(19) United States
(12) Patent Application Publication
(10) Pub. No.: US 2025/0315929 A1
(43) Pub. Date: Oct. 9, 2025

(54) TECHNIQUES FOR IMAGE-BASED OPERATIONAL HEALTH DETECTION

(71) Applicant: Oracle International Corporation, Redwood Shores, CA (US)

(72) Inventors: Daniel M. Vogel, Seattle, WA (US); David Leavitt Boneparth, Portland, ME (US)

(73) Assignee: Oracle International Corporation, Redwood Shores, CA (US)

(21) Appl. No.: 18/630,102

(22) Filed: Apr. 9, 2024

(51) Int. Cl. G06T 7/00; G01J 5/00; G06T 7/90

(52) U.S. Cl. CPC G06T 7/0002; G01J 5/0096; G06T 7/90; G06T 2200/24; G06T 2207/10032; G06T 2207/10048; G06T 2207/20081

(57) ABSTRACT

Techniques discussed herein relate to an image based operational health detection which involves obtaining one or more images depicting an aerial view of a physical structure. The method for obtains one or more attributes associated with the physical structure and identifies a surface temperature corresponding to a portion of the physical structure from the one or more images depicting the aerial view of the physical structure. In addition, the method may determine a temperature control system associated with the physical structure is likely operating a reduced capacity based at least in part on the surface temperature and the one or more attributes associated with the physical structure and execute one or more operations based at least in part on determining that the temperature control system associated with the physical structure is likely operating the reduced capacity.

### BACKGROUND

Datacenters are becoming more common as reliable cloud computing processes become a predominant factor in commercial business success leading to high demand for server use within the datacenters across the world. Datacenters are typically equipped with cooling infrastructure that cool servers within the datacenter which heat up when performing operations like data storage and transfer. The cooling infrastructure is usually provided by various conditioning devices including heating, ventilation, and air conditioning units, commonly referred to as “HVACs”, that may be installed on the datacenter's premises and provide cooling to rooms within the datacenter. When server demand peaks and/or when conditioning components fail, the cooling infrastructure may no longer be able to effectively cool the servers, potentially resulting in widespread server failure, causing significant disruption to at least the downstream devices, resulting in reduced processing capabilities within the datacenter and/or datacenter failure, which in turn leads to a poor user experience. In worst-case scenarios, environmental factors may also contribute to issues experienced by datacenters. During various times of the year, temperatures may rise (e.g., to 38 degrees Celsius/100 degrees Fahrenheit), placing restrictions on how well the cooling infrastructure can remove heat from the datacenter this operating at a reduced capacity. If the cooling infrastructure begins to operate at a reduced capacity, the rooms in the datacenter may begin to warm up which could lead to a server failure. If the cooling infrastructure can effectively cool the rooms in the datacenter, it can trigger a cascading server failure within the same datacenter or within other datacenters as workloads are redistributed in an attempt to recover from the initial issue. Preempting failures and/or operational capacity reductions can provide advantages with respect to mitigating or eliminating the inherent negative effects of these events.

### BRIEF SUMMARY

Techniques are provided for techniques for image-based operational health detection. Various embodiments are described herein, including methods, systems, non-transitory computer-readable storage media storing programs, code, or instructions executable by one or more processors, and the like.

One embodiment is directed to a computer-implemented method for obtaining one or more images depicting an aerial view of a physical structure. In some embodiments, the method may obtain, by the computer system, one or more attributes associated with the physical structure. The method may comprise identifying a surface temperature corresponding to a portion of the physical structure from the one or more images depicting the aerial view of the physical structure. The method may further comprise determining that a temperature control system associated with the physical structure is likely operating a reduced capacity based at least in part on the surface temperature and the one or more attributes associated with the physical structure. The method may further comprise executing one or more operations based at least in part on determining that the temperature control system associated with the physical structure is likely operating the reduced capacity.

In some embodiments, the method comprises one or more images that is an infrared image that depicts a heat signature at one or more corresponding locations of the physical structure. In some embodiments, the method comprises identifying the surface temperature corresponding to at least the portion of the physical structure and further comprising identifying at least one of a color or an intensity of the color within the one or more images.

In some embodiments, the method comprises one or more attributes associated with the physical structure. In some embodiments, the one or more attributes comprises at least one of 1) operational data corresponding to one or more devices associated with powering or managing temperature within the physical structure, 2) location data identifying corresponding locations of the one or more devices associated with powering or managing the temperature within the physical structure, 3) environmental data indicating at least one or more ambient temperature values within the physical structure, 4) one or more ambient temperature values within the physical structure, or 5) a schematic of the physical structure.

In some embodiments, the method comprises obtaining the one or more attributes of the physical structure. In some embodiments the method comprises identifying one or more temperature control systems from the one or more images based at least in part on an object detection algorithm.

In some embodiments, the method comprises one or more images that are obtained at a first frequency. In some embodiments, the method comprises modifying the first frequency to a second frequency, the second frequency being more frequent than the first frequency.

In some embodiments, the method comprises at least one of: 1) enforcing a power cap on at least one of a plurality of servers within the physical structure; 2) migrating a workload from the server; or 3) shutting down or pausing the server.

In some embodiments, the method comprises determining that the temperature control system is likely operating at the reduced capacity. In some embodiments, the method comprises comparing the surface temperature from the one or more images depicting the aerial view of the physical structure to at least one attribute of the one or more attributes associated with the physical structure.

In some embodiments, a computing device is disclosed. The computing device may be configured with one or more processors and one or more memories configured with executable instructions that, when executed by the one or more processors, cause the computing device to perform the method disclosed in the paragraph above.

Some embodiments disclose a non-transitory computer-readable storage medium comprising computer-executable instructions that, when executed with one or more processors of a computing device, cause the computing device to perform the methods disclosed herein.

### BRIEF DESCRIPTION OF THE DRAWINGS

FIG. 1 depicts an example physical environment (e.g., a datacenter or some portion thereof) that includes a variety of components, in accordance with at least one embodiment.

FIG. 2 is a schematic depicting an aerial view of geographical area within which a building (e.g., a datacenter, or some portion thereof) is located, according to at least one embodiment.

FIG. 3 depicts an example infra-red satellite image of the geographical area of FIG. 2, according to at least one embodiment.

FIG. 4 illustrates an example architecture of a monitoring and detection system that is configured to monitor and detect changes in various resources of a physical environment, in accordance with at least one embodiment.

FIG. 5 illustrates an example architecture of a monitor and detection service of FIG. 4, in accordance with at least one embodiment.

FIG. 6 illustrates a flow depicting an example method for training one or more machine-learning models, in accordance with at least one embodiment;

FIG. 7 is a schematic of an example user interface, in accordance with at least one embodiment.

FIG. 8 is a block diagram illustrating an example method for detecting hypervisor unresponsiveness, in accordance with at least one embodiment.

FIG. 9 is a block diagram illustrating one pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The present disclosure relates to techniques for image-based operational health detection within an environment (e.g., a datacenter, or portion thereof). More particularly, techniques are described for using image-based detection of heating events and/or environmental conditions of datacenters. In some embodiments, countermeasure operations or other remedial actions may be implemented based on detection said hearing events and/or environmental conditions.

Identifying when a datacenter may be experiencing a potential issue is desirable. When the datacenter experiences a high demand by customers, it places a significant burden on servers within the datacenter. As the servers work to process the inbound and outbound data, the servers emit heat to the ambient environment which is usually a temperature-controlled room or warehouse. Many datacenters use strict cooling procedures to ensure that the rooms which contain the servers do not significantly increase in temperature. Circumstances may arise that prevent the room from maintaining a cool temperature which can have detrimental effects on the servers. If servers heat up to dangerous levels, they may implement automatic shutdown procedures or data migration protocols to prevent damage to the hardware. In situations where this happens in a short amount of time, these scenarios may or may not be communicated to the customer in the moment which can lead to costly service outages and lost productivity. However, one side effect of unexpected loss of cooling is that the datacenter may begin to heat up in various locations which may be visible from a birds-eye view (e.g., in an infrared spectrum such as that depicted in infrared images).

Advances in satellite imagery have largely enabled agricultural environments to be vigorously imaged to determine environmental conditions. As such, satellite imagery providers are becoming increasingly common and enable frequent high-resolution imagery in both the visible and non-visible spectrums such as infrared. Infrared images are used commonly to determine surface temperature conditions since heat transmits readily through material surfaces such as walls or roofs where visible light may not penetrate. Infrared imaging is also useful in providing relatively high-resolution images due to the relative short wavelength of imaging typically between seven hundred and one thousand nanometers. The high resolution of images may be used to identify points of interest such as hot spots, features (e.g., how many buildings are emitting heat), or heating events in which the heat within a building (e.g., a datacenter) may rise to a problematic level. The frequency of capturing images is also beneficial in tracking environments over long periods of time such as season to season tracking. Frequent capturing of images is useful in determining changes and providing a visual indication of an environment's behavior over time such as a datacenter environment from Spring to Winter.

Conventional datacenters may utilize power capping to constrain operations at power-consuming devices or data migration within the datacenter which may aid in helping the cooling infrastructure in cooling the rooms with servers in them. However, in situations where the datacenter is owned by a managing party and a separate, third-party leases or rents the server capabilities, data migration may not be possible if another datacenter is not available for migration or if the cooling capability of the system is already beyond operating limits before data migration can begin thus creating a service outage and prompting a loss in productivity.

An efficient method of monitoring datacenter cooling is necessary to reduce a possibility of service outages, pre-emptively migrate data to avoid loss of productivity for the customer, and notifying individuals that a datacenter may be about to experience a potential overheating event. Monitoring a datacenter using satellite imagery may provide insight into operations of one or more components of the datacenter such as a group of HVAC units. The satellite may take infrared images over time (e.g., over the course of a few days). These images may be transmitted, or otherwise obtained, by a datacenter health monitor system. At any suitable time, the datacenter health monitor may identify that the datacenter has increased in temperature. This increase in temperature may indicate that the datacenter is experiencing or is about to experience reduced cooling capability which may trigger an event which may cause a service outage. By utilizing satellite infrared imaging techniques, datacenter monitoring may improve response times for performing remedial actions. In some embodiments, these remedial actions may include providing notifications relating to datacenter operations. Techniques described herein minimize chances of service outages due to overheating datacenters, enable robust models to be constructed to characterize datacenter temperature fluctuations and maintenance schedules, enable pre-migration of data from datacenters that are expected to be relying on backup diesel generators thus minimizing carbon footprints of datacenters, all while maintaining minimal to no interference in the day-to-day operations of the datacenter.

Additionally, systems and methods provide an automated and dynamic approach to monitoring parameters related to a health of a datacenter. In some embodiments, at least a portion of the functionality executed toward these actions are user-selectable and/or based on user input. The described techniques provide an enhanced datacenter health monitoring system by utilizing infrared image analysis to determine attributes associated with a datacenter. The infrared images may be captured by one or more satellites (e.g., a constellation of satellites) that image areas associated with a datacenter (e.g., areas associated with datacenters all around the world). The infrared images may be analyzed to identify surface temperatures and attributes associated with the datacenters. The infrared images may be captured over time, enabling a dynamic and adaptive time evolution of datacenter features which are visibly identifiable. Example changes may include increased heat exhaust from various cooling equipment like HVACs and cooling trailers. These changes may also be supported with temperature readouts from various temperature gauges within the datacenter. Various modeling techniques including the use of artificial intelligence may identify areas of interest, trends, and changes, and may be used to predict whether datacenters may experience a potential issue. If a potential issue is identified, relevant users may be notified that the datacenter is experiencing or is about to experience the potential issue and action may be taken to ensure data reliability by migrating data to reduce server loads and thus temperatures associated with the datacenter. In some embodiments, any suitable number of remedial actions may be employed by one or more systems to mitigate or eliminate the negative effects of a heating event. By way of example, the management system(s) may perform any suitable combination of power capping one or more servers, migrating workloads to other servers, shutting down or pausing workloads and/or devices, or the like. In some embodiments, these remedial actions may be performed in an automated fashion and triggered by the image-based detection techniques discussed herein.

Embodiments described herein address these and other problems, individually and collectively.

The techniques described above provide real time capabilities for reducing an impact of reduced cooling capacity of datacenters which may have detrimental effects on customers utilizing the affected datacenter. The systems and methods described herein provide a more efficient and effective health monitoring approach than conventional systems, which may lead to a more satisfactory user experience. The particular actions implemented can be selected (e.g., by the system automatically, through user selection, etc.) based at least in part on any suitable combination of 1) identifying a potential datacenter issue before it happens, 2) identifying pre-emptive measures to ensure data safety and reliability, 3) monitoring a datacenter in a no-impact passive manner, 4) enhancing predictability of datacenter cooling in dynamic climates prone to change, 5) providing pre-emptive alerts to users to protect hardware/infrastructure damage during shifting weather patterns.

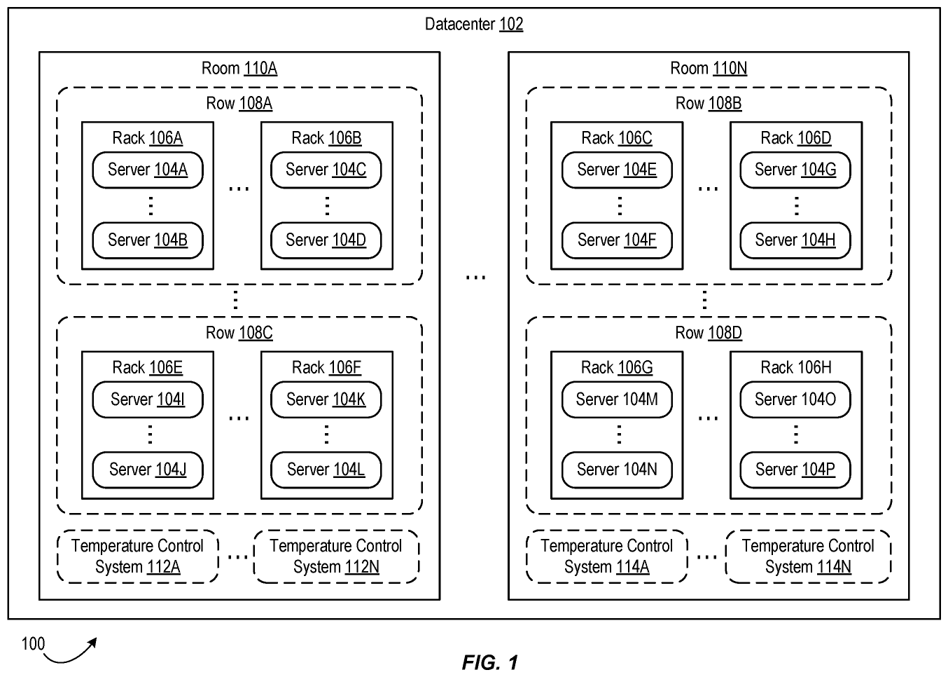

Moving on to FIG. 1, which depicts an example environment (e.g., environment 100) including a variety of components, in accordance with at least one embodiment. Environment 100 may be a physical environment such as a datacenter (e.g., datacenter 102) or portion thereof (e.g., a room of the data center such as room 110A). Environment 100 may include a dedicated space that hosts any suitable number of servers, such as servers 104A-P (collectively referred to as “servers 104”), and the infrastructure for hosting those servers such as networking hardware, cooling systems (also referred to as “temperature control systems”), and storage devices. Servers 104A-P may also be referred to as “hosts.” Networking hardware (not depicted here) of the environment 100 (e.g., datacenter) can enable remote users to interact with the servers over a network (e.g., the Internet). Any suitable number of server(s) 104 (e.g., 10, 14, 21, 42, etc.) can be held in various racks such as racks 106A-H (collectively referred to as “racks 106”). Racks 106 can include a frame or enclosure to which corresponding sets of servers are placed and/or mounted.

Various subsets of racks 106 can be organized into groups called “rows” (e.g., rows 108A-D, collectively referred to as “rows 108”). In some implementations, the rows 108 can include any suitable number of racks (e.g., 5, 8, 10, up to 10, etc.) that are collocated (e.g., within a threshold distance from one another). In other implementations, rows can be an organizational unit and the racks with a given row can be placed in different locations (not necessarily within a threshold distance of one another). As an example, rows 108 can be located in a room (e.g., room 110A, room 110N, etc.). A room (e.g., room 110A) can be a subdivision of a building or a physical enclosure or physical environment in which any suitable number of racks 106 are placed. In other embodiments, a room can be an organizational unit and the rooms can be located in different physical locations or multiple rooms can be located in a single subdivision of a building.

Various temperature control systems (e.g., temperature control system(s) 112-N, temperature control system(s) 114A-N, etc.) may be configured to manage the ambient temperature in the datacenter or portion thereof. As a non-limiting example, the temperature control system(s) 112-N may be associated with room 110A, while the temperature control system(s) 114A-N may be associated with room 110N. Any suitable number of temperature control systems may be associated with the datacenter and/or a portion thereof. In some embodiments, these temperature control systems can be any suitable heating, ventilation, and air-conditioning (HVAC) device (e.g., an air-conditioning unit), chillers (e.g., cooling water circulation devices that control temperature by circulating a liquid such as water), or the like. In some embodiments, each temperature control system may be associated with a corresponding amount of heat (e.g., an amount of heat produced by a corresponding amount of power consumption of the server(s) 104) for which it is capable and/or configured to manage.

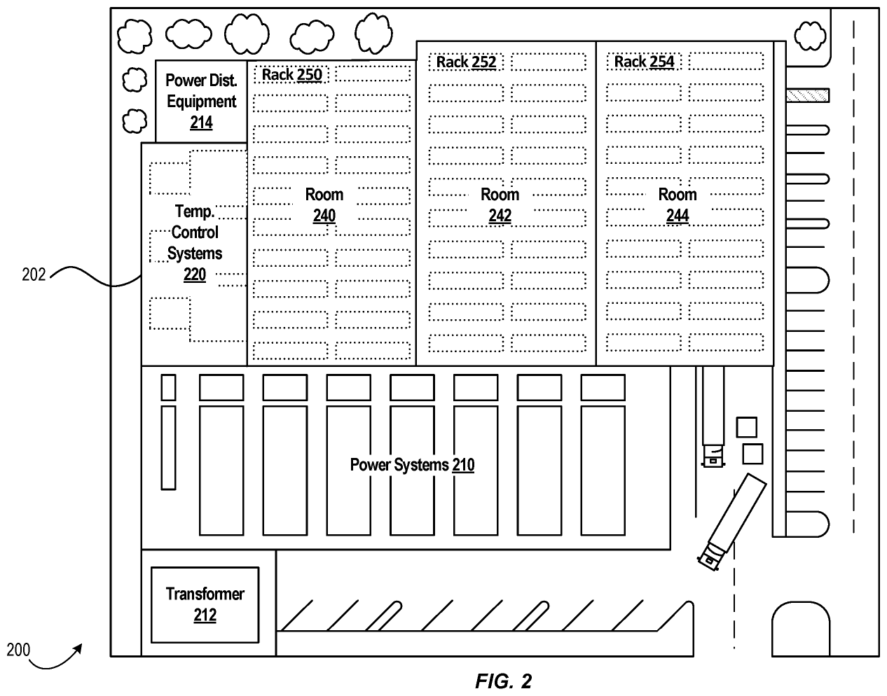

FIG. 2 is a schematic depicting an aerial view of geographical area 200 that is monitored by one or more satellites (not depicted), according to at least one embodiment. The aerial view may include a geographical area 200 that may include any number of objects (e.g., one or more buildings 202, commercial complexes, personnel or vehicles, or geographic features such as trees and mountains or similar). In some examples, a building 202 to be monitored (e.g., a datacenter, or some portion thereof) may include a number of rooms (e.g., room 240, room 242, and room 244 (collectively referred to as “rooms”) for housing various types of computer infrastructure (e.g., rack(s) 250, 252, 254, server(s) 104 of FIG. 1, coolers, or similar). While three rooms are depicted in FIG. 2 for simplicity, any number of rooms may exist within an example building 202. Each of the rooms depicted in FIG. 2 may be an example of room 110A and/or room 110N of FIG. 1 and may be configured to house any suitable number of racks, servers, or the like.

The rooms may be temperature controlled by way of temperature control systems 220 (e.g., temperature control system(s) 112-N, temperature control system(s) 114A-N, of FIG. 1). In some examples, the temperature control systems 220 may include any suitable number and/or portion of HVAC units and may function to moderate temperatures of some or all the rooms in the building 202 similar to the temperature control system(s) 112-N depicted in FIG. 1. For example, room 240 may be a “high load” room with racks 250 (e.g., racks 106A, 106B, 106E, and 106F of FIG. 1) operating at or near capacity thus increasing a local temperature of the room 240. The temperature control systems 220 which monitor the rooms may function to increase a cooling distribution (e.g., allocate additional air-conditioning) in room 240 to ensure that the racks (e.g., rack 250) do not overheat or malfunction. In an example, the temperature control systems 220 may keep the rooms at different temperatures depending on temperature thresholds (e.g., maintaining room temperatures between fifteen degrees and thirty degrees Celsius). The temperatures in the respective rooms may fluctuate depending on loads experienced by racks 250, 252, 254 (e.g., data processing loads, network communication loads, or similar).

The temperature control systems 220 may be powered by power distribution equipment 214. In some examples, the power distribution equipment 214 can be connected to a utility power source (not depicted) and power can initially be received at a substation (e.g., transformer 212) connected to one or more power systems 210. In some examples, the transformer 212 may be one or more transformers that support power system operations (e.g., appropriate voltage conversions) and may emit heat depending on incoming and outgoing power loads. In some embodiments, the power may be received from the utility power source via power systems 210 that are configured to establish suitable voltage levels for distributing electricity through the building 202. Power systems 210 may individually include a specialized battery or generator that provides emergency power if the utility power source fails. Power systems 210 may monitor the utility power source and provide backup power if a drop in the utility power source is detected. The power distribution equipment 214 may be any suitable device that is configured to control and distribute power/electricity. Example power distribution equipment 214 may include, but are not limited to main switchboards, switchboards, remote power panels, bus bars, power strips, transformers, and the like.

The power distribution equipment 214 can include any suitable number of rack power distribution units (PDU(s)) that may be individually configured to power the racks 250, 252, and 254. By way of example, the room 240 may include one or more bus ways. A bus bar (also referred to as a “bus way”) refers to a duct of conductive material that can distribute power (e.g., within the room 240). A bus way can receive power from the power distribution equipment 214 and provide power to one or more racks (e.g., racks 250, 252, 254, etc.) associated with a row (e.g., row 108A of FIG. 1). Each power distribution equipment 214 that distributes/provides power to other components, also consumes a portion of the power that passes through it. This loss can be caused by heat loss from power flowing through the component or by power directly consumed by the component (e.g., power consumed by a processer in a rack PDU). A rack PDU may include any suitable PDU that is disposed between a row (e.g., row 108A) and one or more servers (e.g., server 104A-D, etc.) corresponding to a rack. A “rack PDU” refers to any suitable PDU that is configured to distribute power to one or more servers within a rack. The rack (e.g., rack 250) can include any suitable number of server(s) 104. In some embodiments, rack PDU(s) may include intelligent PDUs that are additionally configured to monitor, manage, and control consumption at multiple devices (e.g., rack PDU(s), server 104A, server 104B, etc.).

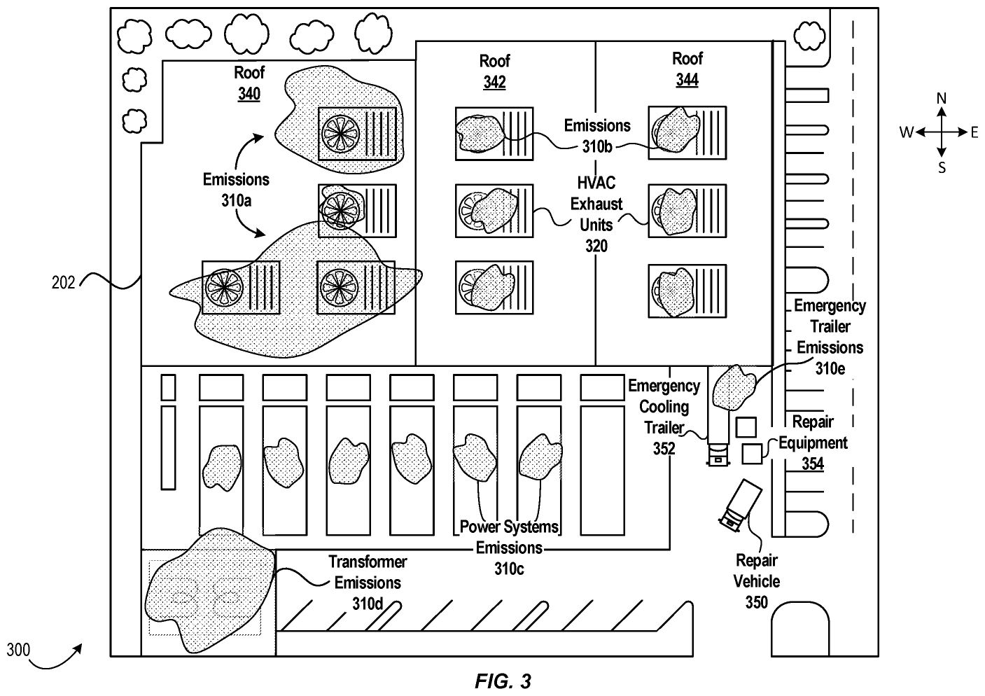

FIG. 3 depicts an example infrared image 300 captured by a satellite of the geographical area 200 of FIG. 2, according to at least one embodiment. In some examples, the infrared image 300 of the geographical area 200 containing building 202 (e.g., a datacenter) of interest may be captured by any suitable Earth observation satellite or constellation of Earth observation satellites capable of capturing one or more spectrums of light (e.g., infrared, visible, near-infrared, or similar). The infrared image 300 may be single spectrum image (e.g., only infrared) or a layered multispectral image (e.g., a partially transparent infrared heatmap image overlayed on a visible spectrum image) of the building 202 in FIG. 2. In some embodiments, the infrared image 300 may include an image of the geographical area of interest in order to detect attributes within the infrared image 300 (e.g., building structures such as roof segments 340/342/344, rooftop HVAC unit(s) 320, or similar) that are quickly recognizable from a birds eye point of view to specific individuals (e.g., users inspecting the images) or recognizable by computer systems (e.g., neural networks implementing image feature extraction). In some examples, the infrared image 300 may include attributes outside of the building 202 such as repair vehicle 350, repair equipment 354, emergency cooling trailer 352, and similar objects that may be located near the building 202 (e.g., within geographical area 200). In various examples, the image may include an infrared heat map (provided by the satellite) of substantially the same geographic area to provide information (e.g., intensity, heat distribution, etc.) related to infrared emissions 310a-310e (collectively referred to as “infrared emissions 310”) of the building 202.

In some examples, the infrared emissions 310 may, at least in part, be a result of a heat exchange process by HVAC unit(s) 320 on a roof of the building working to cool some or all interior rooms of the building 202. For example, as coolers in a room (e.g., room 240 of FIG. 2) of the building 202 inject cold air into the room, a corresponding exhaust heat is generated at one or more condenser/radiators of the HVAC exhaust unit(s) 320 (each a part of a corresponding temperature control system of temperature control systems 220 of FIG. 2) as a result. The heat may be processed away from the building 202 into an ambient environment (typically by air exhaust fan systems or radiant heat exchangers in contact with the ambient environment). This heat exchange process heats up the HVAC exhaust unit(s) 320 as well as environment surrounding the HVAC exhaust unit(s) 320 including the roof segments 340/342/344. Typically, higher loads on the coolers may require more cooling and may generate additional heat in proximity to the building 202. For example, one-thousand square feet of space in the building 202 may require ten tons of cooling by one HVAC unit (e.g., one of the temperature control system(s) 112 of FIG. 1). Larger spaces (e.g., one-hundred thousand ft² to one million ft²) in datacenters may require larger tonnage and numbers of HVAC unit(s) (e.g., temperature control system(s) 112) depending on number and volume requirements of racks 250. In some examples, rooms of the building 202 may have separate cooling arrangements (e.g., different groups of temperature control system(s) 112 which operate independently of one another). In an example, roof segment 340 may have exhaust units corresponding to a set of HVAC unit(s) (e.g., temperature control system(s) 112) for a specific room (e.g., room 240) different from roof segment 342 or roof segment 344 which may each have respective HVAC unit(s) (e.g., temperature control units) for respective rooms (e.g., rooms 242, 244).

In some embodiments, at least some of the infrared emissions may be from a combination of one or more of the HVAC exhaust unit(s) 320 infrared emissions, rooms in the building heating up causing heat to radiate through the roof, or surface emissions on the roof. In various embodiments, additional emissions may be identified (e.g., via object detection or other suitable image processing) in the infrared image 300 such as infrared emissions 310d may be emitted by substation that services the datacenter (e.g., a transformer 212 of FIG. 2) during operations. In further examples, infrared emissions 310c may be representative of heat from power systems during operation. Infrared emissions 310e may represent emissions of an emergency cooling trailer 352 working to support cooling operations of the building 202. While some types of emissions are depicted in FIG. 3, any source and/or type infrared emissions may be represented in the infrared image 300.

In some regions, detected infrared emissions 310 may have a larger surface area and/or intensity (not depicted) in the infrared image 300 than in other regions. For example, the infrared image 300 depicts infrared emissions 310a/310d on roof segment 340 having a relatively larger area than infrared emissions 310b on roofs 342/344. In this example, the larger area of infrared emissions 310a may indicate that the ambient temperature of room 340 has risen to a temperature higher than the ambient temperatures of rooms 342 and 344, as depicted in FIG. 3. Infrared emissions 310a may additionally, or alternatively, indicate that the temperature control system(s) 112 are working harder to cool the room beneath roof segment 340. By comparison, in a non-limiting example, the infrared emissions 310b, 310c, 310e may have a smaller surface area and/or intensity (not depicted) and may indicate that the HVAC exhaust unit(s) 320 on roofs 342/344 have relatively low heat emissions compared to other parts of the building 202 and may be operating at lower cooling settings, are smaller in tonnage, and/or are disabled.

In some embodiments, the intensity of infrared emissions 310 may be represented by heat maps (e.g., gridded average map) which show hot spots or heat loss in a false color spectrum (e.g., applying color by hues or intensity to a data visualization map for light outside of the visible spectrum). For example, infrared emission 310a may be shown as bright red in the false color spectrum indicating relatively hot areas, whereas areas outside of infrared emission 310a may be shown as a dull blue indicating relatively cool areas. The false color spectrum may be a relative measure of infrared light intensity of a “hot zone” as compared to the ambient environment temperature. By way of example, the ambient environment temperature around building 202 may be indicated by color within the image as approximately twenty-one degrees Celsius (approximately seventy degrees Fahrenheit) whereas infrared emissions 310a may be indicated by a different color with the image as approximately forty degrees Celsius (approximately one-hundred degrees Fahrenheit). In some examples, the heat maps may be represented by greyscale colors with large values represented by dark gray or black and smaller values represented by light gray or white. It should be appreciated that any suitable color scale appropriate to show relative intensities (and/or corresponding heat indications is anticipated.

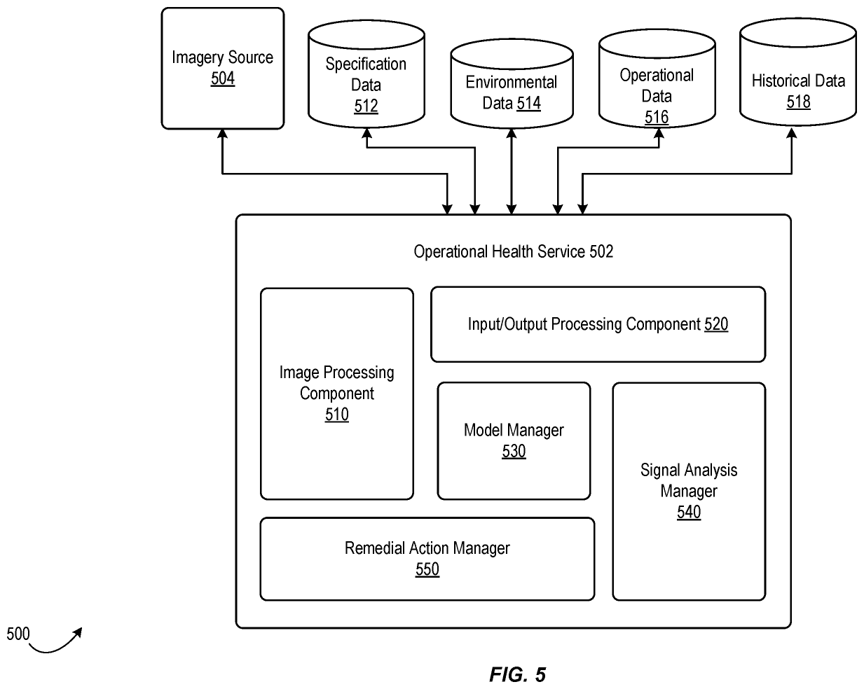

In some embodiments, image processing may be performed on the infrared image 300 (e.g., such as by image processing component 510 of FIG. 5) to detect objects and attributes of the physical structure. For example, a number of HVAC exhaust unit(s) 320 (e.g., from one to a few dozen) present on the roof of the building 202 may be identified and tabulated in memory (e.g., such as in historical data 518). Additionally, a number of power systems 210, substations (e.g., transformer 212), physical structures (e.g., building 202), vehicles (e.g., repair vehicle 350, emergency cooling trailer 352), and objects (e.g., repair equipment 354) may be identified and tabulated. It is contemplated that any suitable processing technique for extrapolating features, attributes, and objects from infrared images may be used.

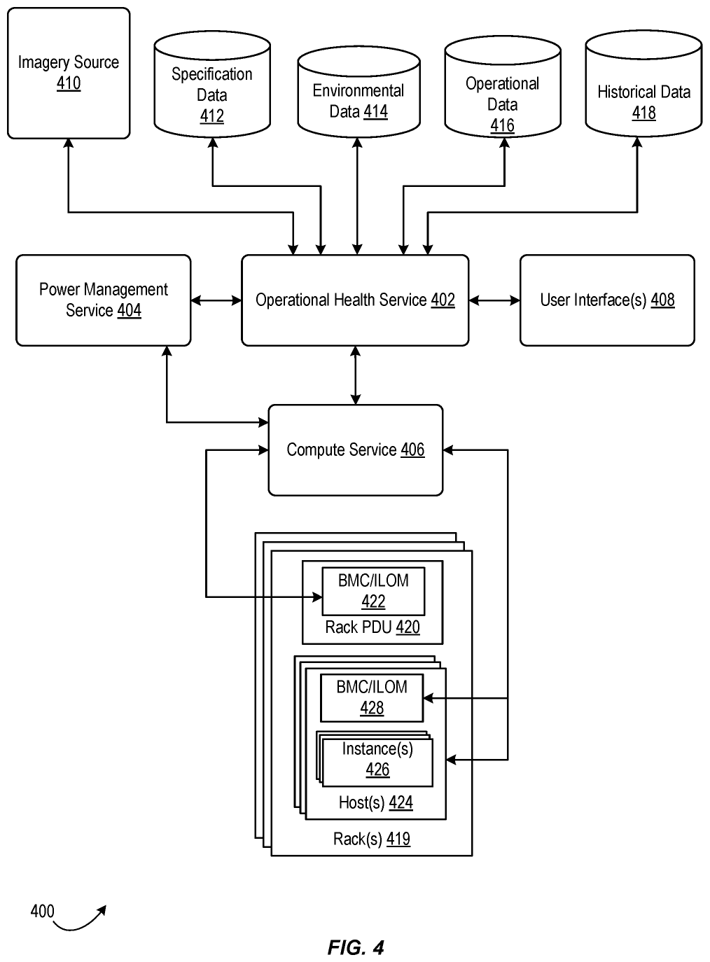

FIG. 4 illustrates an example architecture of a monitoring and detection system 400 that is configured to monitor and detect changes in a physical environment (e.g., a datacenter, a building, an area, etc.), in accordance with at least one embodiment. The monitoring and detection system 400 may include a variety of components such as the ones depicted in FIG. 1, FIG. 2, and FIG. 3. For example, monitoring and detection system 400 may include an operational health service 402 “OHS 402”. The OHS 402 may be configured to obtain various data on which an impact and a remedial action may be determined. By way of example, the OHS 402 may be configured to obtain any suitable combination of: image data from imagery source 410, specification data 412, environmental data 414, operational data 416, and/or historical data 418.

Imagery source 410 may include any suitable image data source which may provide one or more images to the monitoring and detection system 400 such as satellite imaging sources, aircraft imaging sources, unmanned aerial vehicle imaging sources (drones), or similar. The image data from imagery source 410 may be stored in a location that is accessible to the OHS 402 and/or image data from imagery source 410 may be obtained from a source and/or service that is configured to manage and/or obtain such data. In some embodiments, the OHS 402 may be configured to obtain image data from imagery source 410 and store such data at a location from which the data is retrievable by the OHS 402. In some embodiments, the OHS 402 may retrieve and/or store the image data from imagery source 410 with the historical data 418. In some examples, the image data from imagery source 410 may be obtained and/or stored according to a predefined schedule, frequency, or periodicity, or via request.

Specification data 412 may include any suitable attributes of a physical structure or a datacenter. A physical structure or portion thereof (e.g., a room) may correspond with a priority associated with a risk level, or a priority may otherwise be assigned to the physical structure, host, or workload. The risk level may indicate a degree of relational importance such as low risk, medium risk, and high risk, although other risk schemes are contemplated. Another example attribute may include an identifier associated with the physical structure, maintenance schedules, maintenance work, instance, and/or workload. Specification data 412 may be stored at a location accessible to the OHS 402 and from which the specification data 412 is retrievable, or the specification data 312 may be obtained from a service and/or source that is configured to manage and/or obtain such data (e.g., schematic of a physical structure, not depicted). In some embodiments, the specification data 412 to the OHS 402 directly from the source, or component configured to obtain such data, according to a predefined schedule, frequency, or periodicity, or via request.

Environmental data 414 may include any suitable data associated with the physical environment or environmental data indicating external conditions (e.g., such as conditions in proximity to building 202 of FIG. 3). By way of example, environmental data 414 may include an ambient temperature reading of the physical environment, an external temperature outside of the physical environment, a design point indicating an external temperature for which the physical environment was designed to withstand, or the like. At least some portion of the environmental data 414 may be collected from one or more sensor(s) (not depicted) that are configured to measure a particular condition such as the ambient temperature within the physical environment, an external temperature occurring outside the physical environment, or the like. In some embodiments, at least a portion of environmental data 414 may be provided by weather sources such as weather forecasts that are stored within storage of the monitoring and detection system 400, or obtainable from external sources such as weather forecasting websites. By way of example, environmental data 414 may include any suitable meteorological data (e.g., wind speed and/or direction, humidity, dew point, a temperature associated with geographical area 200 of FIG. 2 (e.g., the area external to the building 202), cloud cover, visibility, precipitation amount, or the like. In some embodiments, the environmental data 414 may include tables and/or protocols from which a reduced capacity/capability may be determined/identified. By way of example, a table or mapping may be included in environmental data 414 indicating that a particular difference between an ambient temperature and a temperature occurring outside of the physical environment (referred to as “an external” temperature) is associated with a particular reduced capacity of the power consumption that is capable of being managed by the components, or an individual component, of the system. Environmental data 414 may be stored at a location accessible to the OHS 402 and from which the environmental data 414 is retrievable, or the environmental data 414 may be obtained from a service and/or source that is configured to manage and/or obtain such data (e.g., a metrics service of a cloud computing environment, the power management service 404, etc.). In some embodiments, the environmental data 414 connects to the OHS 402 directly from the source, or component configured to obtain such data, according to a predefined schedule, frequency, or periodicity, or via request.

Operational data 416 may include any suitable data associated an operational status or condition corresponding to one or more devices or components of the physical environment. In some embodiments, operational data 416 may include host instance and/or workload data (e.g., data obtained from compute service 406). As a non-limiting example, operational data 416 may include the operational status of one or more temperature control systems (e.g., temperature control system(s) 112 of FIG. 1 or HVAC unit(s) 320 of FIG. 3). The operational status may include a target temperature for a room, a current temperature of the room, or similar metrics associated with the temperature control systems. In some embodiments, the operational data 416 may indicate which temperature control systems are operational and/or an operational capacity for those systems. In some embodiments, the operational data 416 may include tables and/or protocols from which a reduced capacity/capability may be determined/identified. By way of example, a table or mapping may be included in operational data 416 indicating that failure (e.g., complete or partial) of a particular component (e.g., a particular temperature control system) is associated with a particular reduced capacity of the power consumption that is capable of being managed by the components of the system as a whole, or an individual component of the system. At least some portion of the operational data 416 may be originally obtained and/or maintained by a separate service (e.g., power management service 404, or the like). Operational data 416 may be stored at a location accessible to the OHS 402 and from which the operational data 416 is retrievable, or the operational data 416 may be obtained from a service and/or source that is configured to manage and/or obtain such data (e.g., compute service 406, etc.). In some embodiments, the operational data 416 may be provided to the OHS 402 directly from the source, or component configured to obtain such data, according to a predefined schedule, frequency, or periodicity, or via request.

Historical data 418 may include any suitable data associated with one or more examples of the image data from imagery source 410, specification data 412, environmental data 414, operational data 416, and/or other components of the monitoring and detection system 400. As a non-limiting example, historical data 418 may include one or more images or data representing one or more images associated with the monitoring and detection system 400 (e.g., infrared heat maps of FIG. 3). In some embodiments, the historical data 418 may include the specification data 412 including the attributes of a physical structure associated with images of the physical structure over time (e.g., from a day to a few months, over a year, over a season, for the last month, etc.). The historical data 418, in some examples, may include environmental data 414 such as measurements of an ambient temperature reading of a physical environment from a prior time period (e.g., a few minutes to a few years of prior data, a last month's worth of measurements, etc.). In a non-limiting example, the historical data 418 may store ambient temperature readings local to a datacenter in Los Angeles California for the previous seven days and may store ambient temperature readings local to a datacenter in Tokyo Japan for the previous four years. The length of time for which historical data is stored may be configurable (e.g., via a configuration file and/or via user input provided at a user interface managed by the OHS 402). In another example, the historical data 418 may include operational data 416 that may include an operational status of one or more temperature control systems (e.g., temperature control system(s) 112 of FIG. 1). For example, the historical data 418 may include data which temperature control systems were operational and which temperature control systems were not operational during the same time period the previous year. In some embodiments, the historical data 418 may be provided to the OHS 402 directly from the source, or component configured to obtain such data, according to a predefined schedule, frequency, or periodicity, or via request.

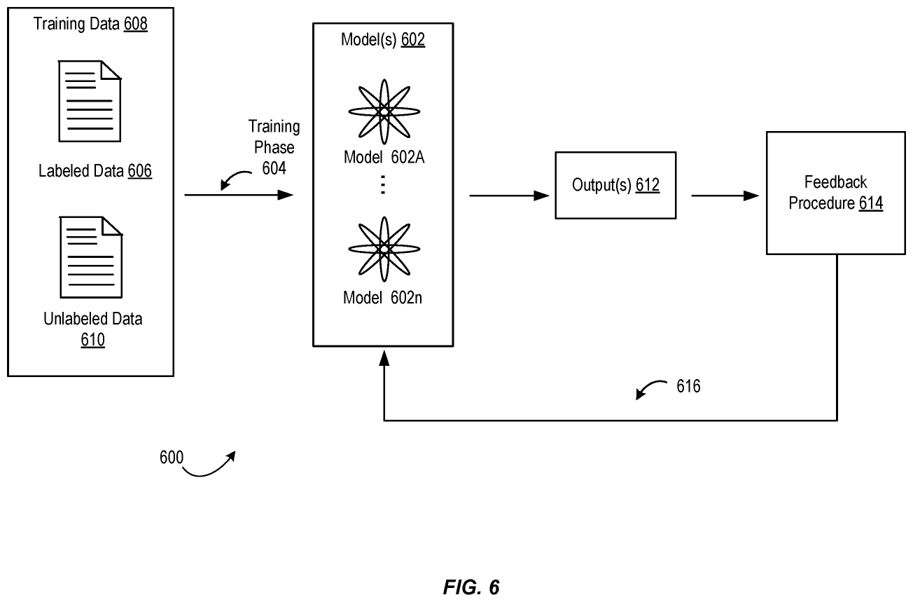

It should be appreciated that image data from imagery source 410, specification data 412, environmental data 414, or operational data 416 may include current data indicating current values and/or historical data 418 indicating corresponding historical values. In some embodiments, future attributes of specification data 412, environmental data 414, or operational data 416, may be predicted based at least in part on the historical data 418 or historical data pulled from another suitable data source such as the Internet. In some embodiments, machine learning may be utilized to predict any suitable portion of these future attributes. Example methods for predicting future values for specification data 412, environmental data 414, or operational data 416, are discussed in more detail with respect to FIG. 6. In some embodiments, the OHS 402 may be configured to aggregate the data of any suitable combination of image data from imagery source 410, specification data 412, environmental data 414, operational data 416, or historical data 418 into a table, mapping, or database from which the data may be filtered or sorted to identify a subset of resources (e.g., hosts, instances, workloads, customers) for a given set of constraints (e.g., low-priority workloads, free tier customers, etc.).

The monitoring and detection system 400 may be configured to monitor an aerial view (e.g., infrared image 300) of a geographical area of interest that may include at least a portion of a physical structure (e.g., building 202 of FIG. 3) using the imagery source 410 (e.g., a satellite imager). In an example, imagery source 410 may capture one or more images of the geographical area of interest where a known datacenter exists. The imagery source 410 may capture the one or more images using any suitable number of cameras. The camera may be the same type of cameras or may be different depending on a desired type of images. In a non-limiting example, the imagery source 410 may utilize an infrared camera, a visible spectrum camera, and/or a near-infrared camera to capture images of the geographical area of interest. The imagery source 410 may provide some or all of the images to the OHS 402 or may provide images that were selected in desired electromagnetic spectrums (e.g., user defined or automatically by a machine learning model such as models 602 of FIG. 6). In some embodiments, the imagery source 410 may receive requests from the OHS 402 to capture images of the geographical area of interest in response to data from one or more of specification data 412, environmental data 414, operational data 416, or historical data 418. The imagery source 410 may provide images including aerial views of one or more physical structures. In an example, the imagery source 410 may capture an infrared image of a datacenters roof which includes temperature control system 112A of FIG. 1 or components of temperature control system(s) 112 (e.g., HVAC exhaust unit(s) 320 of FIG. 3). The imagery source 410 may capture the images according to a predefined schedule, frequency, or periodicity, or via request.

The monitoring and detection system 400 may be configured to detect one or more attributes (e.g., using image processing component 510 of FIG. 5) from the images provided by the imagery source 410. In a non-limiting example, the one or more attributes may include physical structure features such as edges, corners, ridges, roofs, temperature control systems (e.g., temperature control system(s) 112 of FIG. 1 which include HVAC exhaust unit(s) 320 of FIG. 3), power systems (e.g., power systems 210, transformer 212 of FIG. 2), support vehicles (e.g., such as repair vehicle 350 and emergency cooling trailer 352 of FIG. 3) or any suitable attributes for feature detection. The monitoring and detection system 400 may perform feature detection (e.g., interest point detection, feature extraction, feature vector identification, or similar) on the images provided by the imagery source 410. In some embodiments, the monitoring and detection system 400 may utilize one or more of environmental data 414, operational data 416, or historical data 418 to aid in feature detection. For example, the imagery source 410 may capture an image of the physical structure that has been imaged previously. The monitoring and detection system 400 may review historical data 418 for images captured of the physical structure in the past in order to perform a comparison (e.g., identify if new features exist such as a new HVAC system or the presence of a repair vehicle 350 of FIG. 3).

In some examples, the monitoring and detection system 400 may be configured to identify a surface temperature corresponding to at least a portion of the physical structure in one or more images provided by the imagery source 410. For example, the OHS 402 may receive the images from the imagery source 410 and may subsequently search the historical data 418 to retrieve various attributes associated with the physical structure (e.g., one or more previous images, one or more previous heat profiles, one or more specifications, indicator(s) of severe weather event(s), etc.) and the operational data 416 to retrieve various attributes associated with powering the various components associated with the physical structure and/or managing temperature within the physical structure and any other suitable attribute (e.g., ambient temperature or similar). The OHS 402 may use image processing techniques (e.g., apply a heat map) to identify various heat signatures within the image that may correspond to various objects (e.g., roof segment 340, HVAC exhaust unit(s) 320 of FIG. 3, or similar). In some embodiments, the OHS 402 may be configured to utilize object detection techniques to identify particular objects such as HVAC exhaust units, vehicles, construction, faulty equipment, building damage, or the like. The OHS 402 may determine, based at least partially on the heat signatures (and, potentially, its correlation to a detect object such as an HVAC exhaust unit, an HVAC unit, a power control system, a power distribution unit, or the like), that a component associated with the physical structure (e.g., a particular temperature control system such as temperature control system 112A of FIG. 1) is likely operating at a reduced capacity (e.g., are unable to maintain temperature of one or more rooms containing rack(s) 419 in the datacenter below a predefined temperature threshold).

In a non-limiting example, an image (e.g., infrared image 300 of FIG. 3) may be taken of the physical structure that includes two groups of temperature control units. The image may depict respective temperatures (e.g., via heat signatures) of two groups of temperature control units. The respective temperatures may be identified based at least in part on identifying heat signatures as a result of performing an infrared analysis of an infrared image. The infrared analysis may include identifying respective temperatures at various locations of the image and correlating the temperature to a particular component. In some embodiments, a correlation between a heat signature and a particular component of the datacenter may be identified based at least in part on specification data 412 (e.g., by correlating locations of the heat signature(s) to specified locations of one or more components) and/or through detecting one or more objects within the image that correspond to components of the datacenter/building 202 of FIG. 2. The first group of temperature control units may include HVAC exhaust unit(s) 320 of roof segment 340 of FIG. 3. An image obtained from imagery source 410 may appear to show a high intensity of infrared emissions (e.g., similar to infrared emissions 310a in FIG. 3) which may indicate that one or more temperature control units of a first group (e.g., temperature control unit(s) associated with room 340) are operating at a reduced capacity. Operating at a reduced capacity is intended to refer to situations in which a component (e.g., a temperature control system) is faulty, failing, or otherwise unable to manage the temperature of a corresponding area of building 202 to maintain the temperature within an acceptable range and/or below/above a predefined temperature threshold that is associated with that corresponding area. In some embodiments, predefined temperature thresholds for various portions/segments of building 202 may be specified within specification data 414. The second group of temperature control units (e.g., temperature control system(s) 112, including HVAC exhaust unit(s) 320 on roof segment 344 of FIG. 3) may show little to no emissions (e.g., similar infrared emissions 310b of FIG. 3) indicating that the temperature control units may be operating at a reduced capacity or may be disabled. In some embodiments, infrared emissions 310b, without a larger surrounding heat signature indicating an ambient temperature of the roofs 342 and 244 respectively, is above a temperature threshold, may indicate that the temperature control units corresponding to the respective portions of the datacenter (e.g., rooms 252 and 254 of FIG. 2) are operating at acceptable levels.

In response to determining that one or more temperature control units may be operating at the reduced capacity, the OHS 402 may communicate with the power management service 404 to manage at least a portion of the systems (e.g., power consumption or data load on rack(s) 419, host(s) 424, etc.) within the physical structure to help cool the physical structure down. In an example, the OHS 402 may work with the power management service 404 to enforce a power cap on at least one server within the physical structure. In various examples, the OHS 402 may with the power management service 404 and compute service 406 to migrate workloads from at least one server (e.g., such as server(s) 104 in room 244).

In some embodiments, a relative difference in surface temperatures across one or more roofs and/or physical structures may be determined. While in the previous example it was discussed that low or no infrared emissions in proximity to a temperature control unit may indicate that the temperature control unit is operating at a reduced capacity and/or is disabled, it should not be considered a limiting example. For example, emissions on roof segment 342 and 344 of FIG. 3 may represent normal emissions for the associated temperature control units (e.g., temperature control system(s) 112 including HVAC exhaust unit(s) 320). Servers which are cooled by the associated temperature control units may require smaller or fewer temperature control units to achieve the desired cooling. In these examples, the OHS 402 may determine from data sources (e.g., specification data 412, operational data 416, and/or historical data 418) that the surface temperatures detected in the image are normal operation emissions for that portion of the physical structure. The OHS 402 may retrieve historical information associated with each temperature control unit, individually, to determine if the temperature control unit is operating outside of normal thresholds. For example, the physical structure may have specific temperature control requirements (e.g., maintain temperature of room at twenty-one degrees Celsius) that define thresholds. In some examples, determining the relative differences in surface temperatures may be performed across many images (e.g., from a few images to thousands of images). By way of example, temperature profiles may be constructed (e.g., by model 602 of FIG. 6) for each temperature control unit individually or may be constructed as partitioned groups of temperature control units (e.g., by building or respective rooms).

As another example, an emission pattern may be generated from any suitable number of historical images obtained from historical data 418. By way of example, an average pixel value may be calculated from corresponding pixel values of any suitable number of historical images. In some embodiments, through identifying an average pixel value for each pixel (or groups of any suitable number of pixels) in a set of historical images, a map (referred to as a “heat pattern map”) of the geographical area and/or building 202 may be generated). Since pixel values can be grouped, the number of values and/or dimensions of the heat pattern may differ from the number of pixels and/or dimensions of an image map corresponding to the pixels of the image. In some embodiments, this heat pattern map may be used for identifying threshold values such that identifying a difference that exceeds a predefined threshold value may be considered to be indicative of a heating event (e.g., an event that falls outside the normal heat patterns of the geographical area and/or datacenter).

The monitoring and detection system 400 may be configured to monitor a datacenter's (e.g., building 202 of FIG. 2) power consumption levels (e.g., current individual and/or aggregate power consumption values corresponding to variety of hosts such as host(s) 424, each of which are an example of the server(s) 104 of FIG. 1) in response to the OHS 402 performing analysis on image data from imagery source 410. The monitoring and detection system 400 may manage, based at least in part on that monitoring, power consumption within the physical environment such that an aggregate power threshold is enforced. The aggregate power threshold, as used herein, represents a maximum amount of power consumption that is able to be managed by the components of the datacenter 102, given current conditions. The aggregate power threshold may be dynamically adjusted as conditions change (e.g., based on a mandate of a government entity to reduce power consumption, based on environment conditions, real or predicted, based on current power consumption values, real or predicted, based on operational status of various components such as temperature control systems of the physical environment, real or predicted, or the like). The particular impact (e.g., scope, applicability) of the changes made to enforce a current aggregate power threshold may vary based on real time conditions. Some example actions that may be employed to enforce the current aggregate power threshold may be power capping (e.g., enforcing a maximum cap of power consumption at a particular device such as one or more of host(s) 424) or otherwise allocating a budgeted amount of power to any suitable device, pausing or shutting down a host and/or an instance (e.g., a VM or BM) and/or a workload executing at an instance, migrating a workload from one instance to another, migrating a workload from one host to another, or the like.

In some embodiments, OHS 402 may be configured to invoke the functionality of power management service 404 based at least in part on detecting an image-based heating event (e.g., a heat signature that falls outside a predefined range, exceeds a predefined threshold, differs over a predefined amount from historical data and/or a heat pattern map, etc.). In some embodiments, OHS 402 may transmit any suitable data to power management service 404 indicative of the heating event. In some embodiments, the data may indicate a component (e.g., a temperature control unit of temperature control system 112A of FIG. 1) is faulty, failing, operating at a reduced capacity, and/or is otherwise failing to maintain acceptable heat management of a particular portion of the datacenter.

Power management service 404 may be configured to identify and/or modify an aggregate power threshold associated with the physical environment based at least in part on any suitable combination of: image data from imagery source 410, environmental data 414, historical data 418, current/aggregate power consumption values (real or predicted) associated with any suitable combination of the host(s) 424, a received request associated with a government entity (e.g., a local power authority) that mandates/requests particular power reductions or an overall power reduction, potentially for a particular time period (e.g., the next twenty-four hours), current or predicted environmental conditions (e.g., current or predicted ambient temperatures, current or future external temperatures, etc.), current or predicted operational status corresponding to temperature control systems (e.g., current or predicted total/partial failures), or the like.

Power management service 404 may be configured to manage, through associated functionality or functionality provided by other systems and/or services, actual power consumption values corresponding to the hosts/instances/workloads of the physical environment. Managing actual power consumption values may include power capping, pausing a workload, instance, host, shutting down a workload/instance/host, migrating an instance from one host to another, migrating a workload from one instance and/or host to another instance and/or host, or the like.

Power management service 404 may obtain configuration data (e.g., a mapping, a protocol set, rules, etc.) corresponding to a number of response levels. Each response level may be associated with a corresponding set of reduction actions (e.g., power capping, migrating, pausing, shutting down, etc.) that are performable on components of the physical environment (e.g., server(s) 104, etc.). In some embodiments, each set of reduction actions corresponding to a particular level is associated with implementing a potentially different reduction in the aggregate power consumption of the data center. In some embodiments, the plurality of response levels indicate an increasing severity with which reduction actions are performed to reduce the aggregate power consumption of the data center. “Severity” is intended to refer to a relative extent by which the action is disruptive. By way of example, an action of power capping a server may be considered less severe than an action of shutting down the server entirely since, in the former, the server may still provide some processing capability, albeit at a reduced capacity, whereas in the latter, the server provides no processing capability.

Power management service 404 may be configured to utilize the configuration data corresponding to a specification of the response level(s) and their corresponding reduction actions to determine an impact of applying the reduction actions of a given level to the hosts/instances/workloads (collectively, “resources”) of the physical environment. The impact of applying a given action may depend on the current conditions of the resources at run time. In some embodiments, identifying an impact for a given reduction action may include identifying a set of resources and/or customers to which the action, if implemented, is applicable. An estimated impact is therefore intended to refer to a scope, or applicability of a given action or level. Identifying the scope and/or applicability of a given action or level may include identifying the particular resources and/or customers that would be affected by implementing the action or level and/or identifying any suitable attributes associated with the applicable resources and/or customers. As a simplistic example, the OHS 402 may identify that X number of idle host of host(s) 424 would be affected should an action be taken to shut down all idle hosts, that those host(s) are associated with particular customers or a particular number of customers, and/or that the host(s) and/or customers are associated with other attributes such as a category (e.g., free tier), a priority (e.g., high priority), and the like.

Power management service 404 may be configured to estimate an impact and/or an actual power reduction that would likely be experienced for one or more of the levels based at least in part on the configuration data specifying the levels and corresponding actions and any suitable combination of the image data from imagery source 410, specification data 412, environmental data 414, historical data 418, host/instance data, or the like. An estimated impact (e.g., what host(s), instance(s), workload(s), customer(s) would likely be affected, what attributes are associated with the affected host(s), instance(s), workload(s) and/or customers, how many host(s)/instance(s)/workload(s)/customer(s) are affected, etc.) can be identified for one or more response levels, one or more reduction actions corresponding to a given level, or the like. In some embodiments, the estimated impact of a given action may be aggregated with the estimated impacts for all actions of a given level to identify an estimated impact for the given level.

Power management service 404 may be configured to determine an estimated impact and/or an actual power reduction that would likely be experienced for one or more of the levels based at least in part on current data, historical data, or predicted data (e.g., current, historical, or predicted values corresponding to the image data from imagery source 410, specification data 412, environmental data 414, host/instance data, operational data 416, and/or historical data 418).

In some embodiments, the Power management service 404 may be configured to present, recommend, or select automatically a given response level from the set of possible response levels based at least in part on any suitable combination of the estimated impact and/or estimated power reduction that would likely be experienced if the remedial actions corresponding to a given level were implemented (e.g., effectuated). Thus, in some embodiments, a particular level may be recommended and/or selected by the monitoring and detection system 400 based on any suitable combination of: 1) determining a level that, if implemented, would likely to lead to a sufficient, but not overly excessive reduction in power consumption at the resources of the physical environment (e.g., a least amount of power consumption reduction that is sufficient to drop the current power consumption values under the current aggregate power threshold), 2) determining a level that includes the set of least sever actions, or 3) determining a least impactful level or action (e.g., a fewest number of likely affected resources/customers, a set of affected resources and/or customers that have the priorities or categories that indicate the least collective degree of importance, etc.). A least severe level or action, or a least impactful level or action, may be determined regardless of the estimated power consumption reduction likely to be experienced through implementing the level and/or action, or determining the least severe level/action and/or least impactful level/action may be determined from one or more level(s) that, if implemented given current conditions, are estimated to cause a sufficient reduction in power consumption to drop power consumption values to an aggregated value that falls under the current aggregate power threshold.

Power management service 404 may be configured to provide functionality for identifying power cap values for host(s) and/or instances based at least in part on the aggregate power threshold, budget/allocated power thresholds associated with PDU(s), and/or current individual and/or aggregate power consumption values. In some embodiments, the power management service 404 may be configured to identify which resources to apply power caps and/or particular values for those power caps based at least in part on any suitable combination of current, historic, or predicted values of image data from imagery source 410, specification data 412, environmental data 414, operational data 416. In some embodiments, the OHS 402 may trigger and utilize the functionality provided by the power management service 404 for any suitable combination of identifying/modifying a budgeted/allocated power corresponding to one or more resources (e.g., hosts, instances, PDUs, etc.), identifying which or how many resources are applicable, and estimated power reduction values that are likely to be experienced if the action(s) of a given level are implemented. In some embodiments, the power management service 404 may perform some or all of these functions.

The OHS 402 and/or the power management service 404 may provide any suitable combination of user interface(s) 408. User interface(s) 408 may be configured to provide any suitable application metadata corresponding to combination of: current individual and/or power consumption values corresponding to any suitable number or type of resources (e.g., hosts, instances, workloads, etc.) or customers, any suitable attribute (e.g., priority, category, etc.) associated with those resources or customers, a predicted condition (e.g., a change in the aggregate power threshold is predicted), a current condition (e.g., a current aggregate power threshold), an estimated impact (e.g., a number, identifier, or other attribute associated with an impacted host/instance/workload customer), and/or an estimated power reduction (e.g., estimated reductions expected to be experienced if the actions of the level are applied), and/or identification of the action(s) corresponding to a given level. The user interface(s) 408 may present any suitable combination of this application metadata. The application metadata may correspond to any suitable combination of the available response levels. In some embodiments, application metadata corresponding to current/predicted power consumption values and/or a current/predicted aggregate power threshold may be displayed. In some embodiments, the application metadata presented at user interface(s) 408 may correspond to the estimated power consumption reduction and/or estimated impact for any suitable number of levels. In some embodiments, a recommendation of a particular level may be provided (e.g., by the power management service 404 via provided application metadata corresponding to that level or the reduction actions associated with that level) and a confirmation/or rejection of the recommended level may be entered via a selectable option at the user interface(s) 408. If confirmed, the power management service 404 may be configured to execute operations to effectuate the implementation of the confirmed level and its corresponding actions. In some embodiments, the user interface(s) 408 may present application metadata for any suitable number of response levels and/or corresponding reduction actions and one or more options may be provided at the user interface(s) 408 to enable user selection of a particular level and/or action.

Receiving user input indicating selection of a particular level and/or action or confirmation of selection of a particular level and/or action may cause the power management service 404 to execute operations to effectuate the implementation of the confirmed level and its corresponding actions. Effectuating or implementing the confirmed level and/or its corresponding actions may include instructing any suitable component of the power orchestration system (e.g., the power management service 404, the compute service 406) to implement any suitable portion of the level and/or corresponding action(s). Instructing a component or components may include providing any suitable data such as any suitable combination of image data from imagery source 410, specification data 412, environmental data 414, host/instance data, operational data 416 to the component(s) being instructed. In some embodiments, the instructed component may be configured to effectuate the action(s) or level according to the data provided by the OHS 402 or the instructed component may obtain any suitable portion of the data from the location at which the image data from imagery source 410, specification data 412, environmental data 414, host/instance data, operational data 416 is stored.

As a non-limiting example, if the action(s) of the level for which a reduction or impact is to be estimated includes power capping, the power management service 404 may be configured to estimate power caps, estimate individual or aggregate power consumption reductions, and/or effectuate estimated power caps to bring about the estimated individual/aggregate power consumption reduction. In some embodiments, the power caps may be implemented by the power management service 404 directly, or through instructing the compute service 406. Other actions, such as migrating instances or workloads, pausing instances, workloads, or hosts, shutting down hosts, or preventing (at least for a time) future assignment or launches of instances and/or workloads can be identified by the power management service 404 and/or the compute service 406 and effectuated by the power management service 404 through the functionality provided by the compute service 406. In some embodiments, the compute service 306 may be configured to identify potentially affected hosts/instances/workloads/customers and provide such information to the power management service 404 and/or the power management service 304.

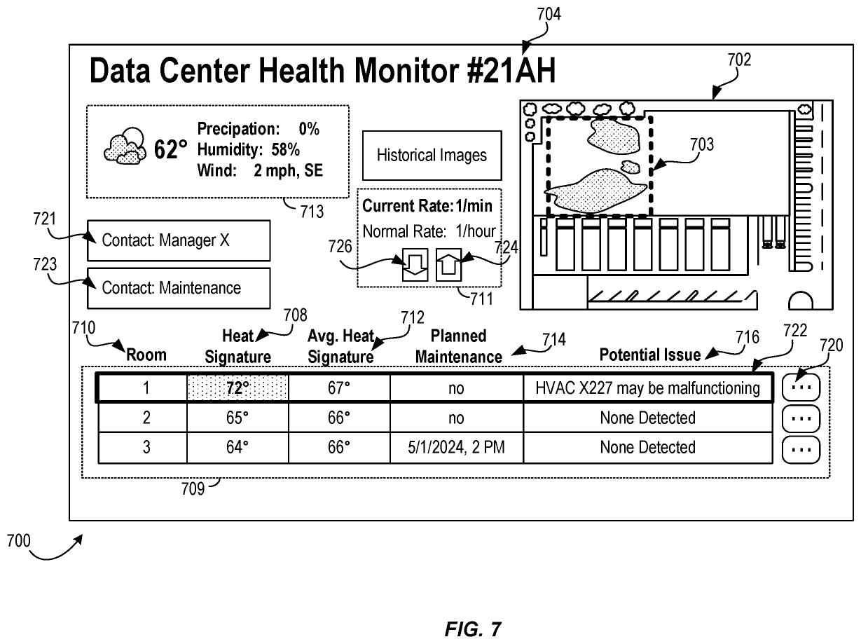

In some embodiments, the OHS 402 may manage one or more of user interface(s) 408, an example of which is described in further detail with respect to FIG. 7. One of more of user interface(s) 408 (e.g., the user interface managed by OHS 402) may depict any suitable combination of data obtained from imagery source 410, specification data 412, environmental data 414, operational data 416, and/or historical data 418.

The compute service 406 may be configured to communicate with baseboard management controller (BMC)/Integrated Lights Out Manager (ILOM) 422 of rack PDU 420. An ILOM is one example of a BMC which is used for illustrative purposes. In some embodiments, the BMC/ILOM 422 may be a specialized service processor that monitors the physical state of the host machine, in this instance, the rack PDU 420. Similarly, host(s) 424 may include a BMC/ILOM 428 that may be a specialized service processor that monitors the physical state of the host, in this instance, one of the host(s) 424. BMC/ILOM 422 and BMC/ILOM 428 may be configured to, among other things, manage and/or enforce budgeted power and/or power caps on the device on which BMC/ILOM 428 operates or to downstream devices. For example, BMC/ILOM 422 may receive power cap values to be utilized by BMC/ILOM 428 to constrain power consumption of a given host. BMC/ILOM 422 may distribute power caps to the corresponding BMC/ILOM 428 to which the power cap relates. In some embodiments, the BMC/ILOM 422 may distribute the power cap(s) which are stored at the applicable host(s), but the enforcement of these power caps is not effectuated until a further instruction is provided by the BMC/ILOM 422 to BMC/ILOM 428. The BMC/ILOM 428 may enforce power caps at the host level and/or at the instance level and/or at a workload level for one or more workloads (not depicted) executing at the instance.

BMC/ILOM 422 to BMC/ILOM 428 may be used to instruct a device (e.g., rack PDU 420 and/or host(s) 424) to pause operations or shutdown a host/instance/workload. In some embodiments, the BMC/ILOM 422 to BMC/ILOM 428 may be instructed to resume operations of a host/instance/workload. If shutdown, a device (e.g., via its BMC/ILOM) may be instructed (e.g., by the compute service 406 and/or by an upstream device such as its PDU) to power up from shutdown. This may include compute service 406 to send instruction(s) to the BMC/ILOM 322 to BMC/ILOM 328 to pause and/or shutdown a host/instance/workload.

In some embodiments, the compute service 406 may execute any suitable operations to migrate a workload from one instance to another (e.g., to an instance on the same host, to a different instance operating at a different host, etc.), to migrate an instance from one host to another (e.g., a host in the same rack, a host in a different rack, etc.), to migrate an instance/workload back to a host that originally hosted the instance/workload that was previously migrated, etc. In some embodiments, the compute service 406 may be configured to ensure that hosts/instances/workloads are not assigned to a host and/or an instance to which a level and/or action that has been effectuated, or is in the process of being effectuated, applies.

Any suitable combination of device(s) (e.g., host(s) 424, rack PDU 420) may include on or more power controllers (e.g., BMC/ILOM 428, BMC/ILOM 422, respectively). A power controller may be any suitable hardware or software component operating at a device (e.g., a server) that is configured to monitor and/or manage power consumption at the device. Power controller may individually monitor the power consumption of the respective device on which it operates. Power controllers may each be configured enforce power cap limits to constrain power consumption at the respective device. Enforcing power cap limits may include monitoring power consumption at the device, determining whether to constrain (e.g., limit, restrict, etc.) power consumption at the device (e.g., based at least in part on a comparison between the device's current consumption and a stored power cap limit), and limiting/restricting power consumption at the device (e.g., using dynamic voltage and/or frequency scaling with processor(s) and/or memory of that device to suppress power consumption at the device). Any suitable operation associated with power capping may be implemented by a power controller.

In some embodiments, a power controller (e.g., BMC/ILOM 422) may communicate via direct connection (e.g., via cable) and/or via network(s) with another power controller (e.g., BMC/ILOM 428) corresponding to one of host(s) 424). Power controller (e.g., BMC/ILOM 428) may provide power consumption data indicating the device's current power consumption (e.g., a cumulative power consumption over a time period, a current rate of power consumption, etc.). Power consumption data can be provided to power controller (e.g., BMC/ILOM 422) at any suitable frequency, periodicity, or according to a predefined schedule or event (e.g., upon breaching a predefined consumption threshold, upon a threshold amount of change in a rate of consumption, upon determining that one or more predefined conditions are met, upon determining a thermal attribute of the device, or the like).

In some embodiments, power controller (e.g., BMC/ILOM 428) may receive a power cap value (also referred to as a “power cap”) from power controller (e.g., BMC/ILOM 422). In some embodiments, additional data may be provided with the power cap value. By way of example, an indicator may be included with the power cap value that indicates whether the power cap value is to be applied immediately. In some embodiments, a received power cap may be applied/enforced immediately by default. In other embodiments, a received power cap may not be applied/enforced immediately by default.

When applying/enforcing a power cap, the power controller (e.g., BMC/ILOM 428) may monitor power consumption at the device. This may include utilizing metering devices or software that is configured to identify/calculate power consumption data for the device (e.g., cumulative power consumption over a time period, a current rate of power consumption, a current change in the rate of power consumption over a time window, etc.). As part of applying/enforcing a power cap (also referred to as “power capping”), the power controller (e.g., BMC/ILOM 428) may determine whether to constrain (e.g., limit, restrict, etc.) power consumption at the device (e.g., based at least in part on comparing the device's current rate of consumption and a stored power cap value). When constraining power consumption at the device, the power controller (e.g., BMC/ILOM 428) may limit/restrict power consumption at the device (e.g., using dynamic voltage and frequency scaling with processor(s) and/or memory to suppress power consumption at the device). In some embodiments, the power controller (e.g., BMC/ILOM 428) may execute instructions to limit/restrict the power consumption of the device when the device's current consumption data (e.g., a cumulative consumption amount, a rate of consumption over a time window, etc.) approaches the power cap value being enforced (e.g., breaches a threshold that is less than the power cap value). When constraining/restricting the power consumption at the device (also referred to as “throttling”), the power controller (e.g., BMC/ILOM 428) ensures that the power consumption of the device remains under the power consumption indicated by the power cap value. The power controller (e.g., BMC/ILOM 428) may be configured to constrain the power at the host generally, or according to the instance and/or workload to which a power cap may apply.

In some embodiments, the power controllers of host(s) 424 may be configured to allow the host(s) 424 to run unconstrained (e.g., without restricting based on power consumption and a power cap) until instructed to apply/enforce a power cap by the power controller (e.g., BMC/ILOM 428). In some embodiments, the power controller (e.g., BMC/ILOM 428) may receive a power cap value that it may or may not later be instructed to enforce, but when received, the power cap value may be stored in memory without being utilized for power management at the device. Therefore, in some embodiments, the power controller (e.g., BMC/ILOM 428) may refrain from commencing with power capping operations (e.g., the comparisons and determinations described above) until instructed to do so (e.g., via an indicator provided by BMC/ILOM 428). The indication to commence enforcement of a power cap can be received with the power cap value or may be received as a separate communication from power controller 448.

Each power controller of one or more PDU(s) (e.g., BMC/ILOM 422) may be configured to distribute, manage, and monitor power with respect to any suitable number of device(s) (e.g., host(s) 424 of rack(s) 419). In some embodiments, the power controller (e.g., BMC/ILOM 422) may be a computing agent or program installed at a given PDU (e.g., rack PDU 420). The power controller (e.g., BMC/ILOM 422) may be configured to obtain power consumption data from the host(s) 424 of rack(s) 419 corresponding to the devices it relates (e.g., the devices for which the given PDU is configured to distribute, manage, or monitor power). Power controller (e.g., BMC/ILOM 422) may receive the consumption data according to a predefined frequency, periodicity, or schedule implemented by power controller (e.g., BMC/ILOM 428), and/or the power controller (e.g., BMC/ILOM 422) may receive the consumption data in response to requesting the consumption data from power controller (e.g., BMC/ILOM 428. The power controller (e.g., BMC/ILOM 422) may be configured to request consumption data from the power controller (e.g., BMC/ILOM 428) according to a predefined frequency, periodicity, or schedule implemented by power controller (e.g., BMC/ILOM 422).

The power controller (e.g., BMC/ILOM 422) may transmit received consumption data to power management service 404 (directly or through compute service 406) at any suitable time, according to any suitable frequency, periodicity, or schedule, or as a result of one or more predefined conditions being met (e.g., a change in a rate of individual/cumulative/collective consumption of the host(s) 424 breaches a threshold). In some embodiments, the power controller (e.g., BMC/ILOM 422) may aggregate the power consumption data received from the host(s) 424 (e.g., via the power controller (e.g., BMC/ILOM 428) of each device) prior to transmitting the aggregated consumption data to power management service 404. In some embodiments, the consumption data may be aggregated by host, instance type/category/priority, workload type/category/priority, or customer.

The power controller (e.g., BMC/ILOM 422) may receive at any suitable time one or more power cap values corresponding to host(s) 424 (e.g., from the power management service 404). These power cap value(s) may be calculated by power management service. In some embodiments, the power controller (e.g., BMC/ILOM 422) may receive a timing value with the power cap value indicating a duration to be used for a timer. The power controller (e.g., BMC/ILOM 422) may be configured to generate and initiate a timer with an associated duration/time period corresponding to the timing value. Upon expiration of the timer indicating the time period corresponding to the time period has elapsed, the power controller (e.g., BMC/ILOM 422) may transmit data to one or more hosts including an indicator or other suitable data that instructs the one or more hosts to proceed with power capping using the power cap value previously stored at each device. In some embodiments, the power cap value may be provided with the indicator. In other embodiments, the power cap value may be provided by the power controller (e.g., BMC/ILOM 422) to the power controllers of the devices (e.g., BMC/ILOM 428) immediately after receiving the power cap value(s) from the power management service 404. Thus, in some embodiments, the power cap values may be transmitted by the power controller (e.g., BMC/ILOM 422) to the power controller (e.g., BMC/ILOM 428, stored in memory, but not enforced by power controller (e.g., BMC/ILOM 422) until power controller (e.g., BMC/ILOM 428) receives the subsequent data from power controller (e.g., BMC/ILOM 422) that instructs the power controller (e.g., BMC/ILOM 428) to commence power capping.

OHS 402, power management service 404, compute service 406, rack PDU 420, host(s) 424 may communicate via one or more wired or wireless networks (e.g., LAN/WAN). Storage devices at which image data from imagery source 410, specification data 412, environmental data 414, operational data 416, and historical data 418 are stored may also communicate with OHS 402, power management service 404, compute service 406, rack PDU 420, host(s) 424 via the one or more wired or wireless connections (e.g., via one or more networks). In some embodiments, the network(s) may include any one or a combination of many different types of networks, such as cable networks, the Internet, wireless networks, cellular networks, and other private and/or public networks. The device(s) of FIG. 4 may be any suitable type of computing device such as, but not limited to a server device, a networking device, or any suitable device within a datacenter.

Each of the device(s) of FIG. 4 may include at least one memory. The processor(s) may each be implemented as appropriate in hardware, computer-executable instructions, firmware, or combinations thereof. Computer-executable instruction or firmware implementations of the processor(s) of the device(s) of FIG. 4 may include computer-executable or machine-executable instructions written in any suitable programming language to perform the various functions described.

The memories of the device(s) of FIG. 4 may store program instructions that are loadable and executable on the respective processor(s) of the given device, as well as data generated during the execution of these programs. Depending on the configuration and type of user computing device, the memories may be volatile (such as random-access memory (RAM)) and/or non-volatile (such as read-only memory (ROM), flash memory, etc.). The device(s) of FIG. 4 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memories may individually include multiple different types of memory, such as static random-access memory (SRAM), dynamic random-access memory (DRAM), or ROM.

Turning to the contents of the memories in more detail, the memories may include an operating system, one or more data stores, and one or more application programs, modules, instances, workloads, or services such as the OHS 402, the power management service 304, the compute service 306, and the like.

The device(s) of FIG. 4 may include communications connection(s) that allow the device(s) to communicate with one another via the network(s) (not depicted). The device(s) of FIG. 4 may also include I/O device, such as a keyboard, a mouse, a pen, a voice input device, a touch input device, a display, speakers, a printer, etc.

FIG. 5 illustrates an example architecture 500 of an operation health service 402 of FIG. 4 (OHS 502), in accordance with at least one embodiment. The OHS 502 may include input/output processing component 520 which may be configured to receive and/or transmit any suitable data between OHS 502 and any other suitable device of FIG. 4. As depicted, the OHS 502 may include an image processing component 510, a model manager 530, a signal analysis manager 540, and a remedial action manager 550, although more or fewer computing components or subroutines may be similarly utilized. In addition, as depicted, the OHS 502 may include and/or receive information an imagery source 504, specification data 512, environmental data 514, operational data 516, and historical data 518, although more or fewer computing components or subroutines may be similarly utilized. In some examples, the imagery source 504, specification data 512, environmental data 514, operational data 516, and historical data 518 may be the same or similar to imagery source 504 data, specification data 412, environmental data 414, operational data 516, and historical data 518 of FIG. 4.

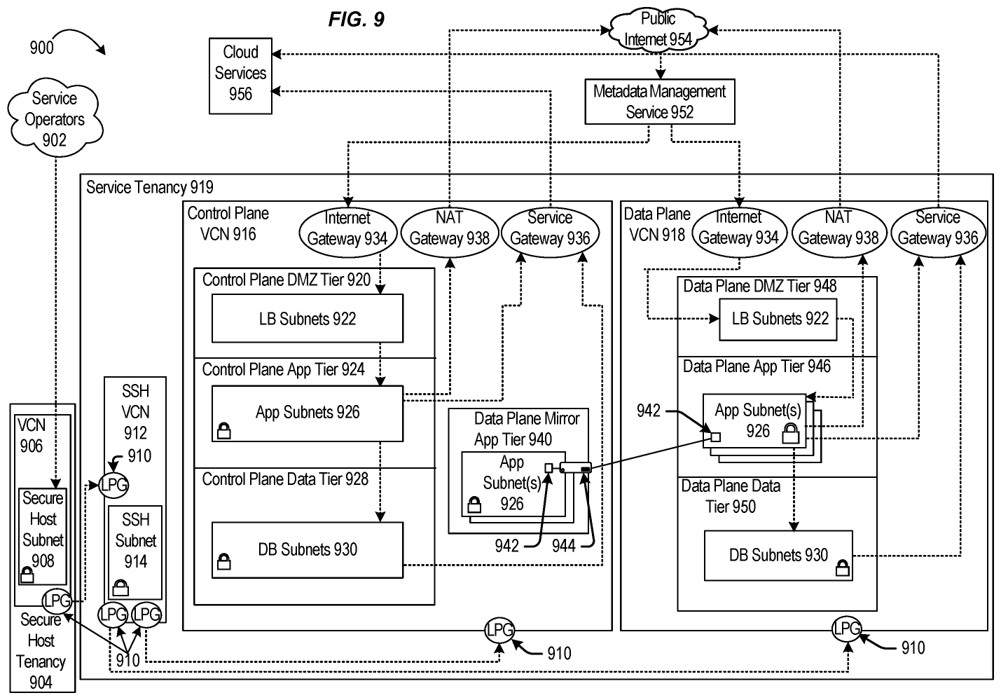

The functionality described in connection with OHS 502 may, in some embodiments, be executed by one or more virtual machines that are implemented in a hosted computing environment (e.g., on host(s) 424, corresponding to any suitable number of server(s) 104 of FIG. 1). The hosted computing environment may include one or more rapidly provisioned and released computing resources, which computing resources may include computing, networking and/or storage devices. A hosted computing environment may also be referred to as a cloud-computing environment. A number of example cloud-computing environments are provided and discussed below in more detail with respect to FIGS. 9-13.

In some embodiments, the OHS 502 (e.g., image processing component 510) may analyze images provided by one or more detectors (e.g., imagery source 504 such as a satellite imager) and/or images from historical data 518. By way of example, image analysis may be performed using any suitable image processing (e.g., to identify temperature values at various locations near or at a physical building as indicated by infrared emissions 310) and/or object detection techniques (e.g., to identify patterns of an object that help identify the object) and/or infrared temperature analysis to determine one or more attributes associated with a physical structure and/or component of the physical structure (e.g., a temperature control unit such as one or more of temperature control system 112A of FIG. 1). These attributes may include, but are not limited to: 1) identifying temperature estimates (e.g., infrared emissions 310 of FIG. 3) across the physical structure and surrounding environment, 2) determining structure configurations (e.g., identifying two separate small buildings or one large building), 3) determining types and/or amounts of cooling equipment (e.g., HVAC brand, tonnage, amount), 4) identifying types and/or amounts of vehicles (e.g., one emergency cooling trailer 352 for cooling), associated with the physical structure, 5) types and/or amounts of facility repair equipment (e.g., two crates of repair equipment 354) or other repair and/or construction activities, 6) types and/or amounts of power equipment (e.g., number of substations and/or emergency backup power systems). The image processing component 510 may function to transmit, retrieve, and/or store analysis information associated with these attributes within specification data 512, environmental data 514, operational data 516, and/or historical data 518 according to a predefined schedule, frequency, or periodicity, or via request. In some examples, the image processing component 510 may function to transmit, retrieve, and/or store analysis information associated with these attributes to the signal analysis manager 540.

In some embodiments, the OHS 502 (e.g., the model manager 530) may receive and/or request information related to the attributes from one or more of the image processing component 510, the specification data 512, the environmental data 514, the operational data 516, and/or the historical data 518, to generate an operational health model for a physical structure that was imaged. In some examples, the operational health model may be generated (e.g., using method 600 of FIG. 6) using one or more images from the imagery source 504. The operational health model may additionally include attribute information from one or more of the specification data 512, the environmental data 514, the operational data 516, and/or the historical data 518. For example, the model manager 530 may receive a schematic of the physical structure from the specification data 512. The model manager 530 may determine that the physical structure may have a specific number of coolers (e.g., temperature control system(s) 112 including HVAC exhaust unit(s) 320 of FIG. 3 located on the roof) based on the schematic and/or the image. In a non-limiting example, the model manager 530 may retrieve environmental data 514 such as a current ambient environment temperature and a weather report for the area (e.g., wind is thirteen miles per hour North-East with humidity at fifty-one percent). The model manager 530 may correlate and/or collate (e.g., using method 600 of FIG. 6) the environmental data 514 with the specification data 512 to determine the current conditions of the physical structure (e.g., ambient temperature is twenty-one degrees Celsius, the schematic matches at least a portion of the physical structure in the image, and internal room temperature is twenty-eight degrees Celsius). Any suitable combination of the image analysis data generated by the image processing component 510 and/or data from any suitable combination of imagery source 504, specification data 512, environmental data 514, operational data 516, and/or historical data 518 may be input into the model manager 530 to train, update, or create the operational health model. By way of example, the model manager 530 may determine that a specific physical structure is known for having unreliable cooling infrastructure (e.g., temperature control system(s) 112 including HVAC exhaust unit(s) 320 of FIG. 3 typically fail when environmental temperatures exceed forty degrees Celsius). In this example, the model manager 530 may assign a health score to the physical structure (e.g., one to ten, with ten being the most reliable). As another non-limiting example, the model manager 530 may provide any suitable output of one or more machine-learning models to which any suitable data described above may be provided as input. In some embodiments, output(s) provided by these model(s) may indicate a degree of actual or potential failure, reduced capacity, or the like for one or more temperature control units. In some embodiments, a confidence value corresponding to the actual and/or potential failure, reduced capacity, or other output values may be included. A confidence value may indicate a degree of confidence or likelihood (e.g., a value between 0 and 1, where 1 indicates 100% certainty/likelihood, and 0 indicates total lack of certainty/likelihood) that the failure, reduced capacity, or other situation indicated by the output value(s) is likely accurate. In some examples, the model manager 530 may function to transmit, retrieve, and/or store analysis information associated with these attributes to the signal analysis manager 540 according to a predefined schedule, frequency, or periodicity, or via request.

In some embodiments, the OHS 502 (e.g., the signal analysis manager 540) may receive and/or request signals from one or more of the input/output processing component 520, the image processing component 510, the model manager 530, the remedial action manager 550, the specification data 512, the environmental data 514, the operational data 516, and/or the historical data 518 according to a predefined schedule, frequency, or periodicity, or via request. In some examples, the signal analysis manager 540 may function to collect information at least one source (e.g., image processing component 5110, model manager 530, etc.) to determine whether or not an event (e.g., surface temperature increase/decrease) has occurred or may occur. In a non-limiting example, the signal analysis manager 540 may receive an image analysis from the image processing component 510 that includes an identified physical structure which has coolers (e.g., temperature control system(s) 112 including HVAC exhaust unit(s) 320 of FIG. 3) located on the roof of the physical structure and at least one corresponding heat signature (e.g., surface temperatures) at one or more locations on the physical structure. In addition, the signal analysis manager 540 may request information from the specification data 512 regarding receiving a schematic associated with the physical structure as well as location data identifying corresponding locations of one or more devices associated with powering and managing a temperature within the physical structure.

In this non-limiting example, the signal analysis manager 540 may first determine that the image received from the imagery source 504 is associated with an existing physical structure in the historical data 518 (e.g., comparing image similarities, identifier numbers, etc.). If it is determined that the physical structure had not been previously imaged, the signal analysis manager 540 may create and store a new entry along with the image and associated information (e.g., image captured by imagery source 504, a timestamp, specification data, etc.). If it is determined that the physical structure has already been imaged, the signal analysis manager 540 may retrieve operational data 5146 such as an operational status or condition corresponding to one or more devices (e.g., temperature control system(s) 112 including HVAC exhaust unit(s) 320 of FIG. 3) or components of the physical environment.

In this non-limiting example, the signal analysis manager 540 may also retrieve environmental data 514 such as, but not limited to, meteorological data identifying at least one of: 1) an external humidity value, 2) local temperature to the physical structure, 3) cloud coverage in a vicinity of the physical structure (e.g., cloud cover measurement), 4) wind direction and speed (e.g., wind velocity), 5) rain probability in a vicinity of the physical structure, 6) severe weather events such as hail, hurricanes, flash floods, thunderstorms etc., 7) historical weather condition averages, 8) visibility values, 9) extreme hazards (e.g., brush fires or forest fires) or similar. The signal analysis manager 540 may process the collective data provided by any suitable component(s) to determine if the attributes of the image indicate (e.g., a temperature estimate for a portion of the physical structure is outside of normal operations) that a remedial action by the remedial action manager 550 may be needed. In some examples, the signal analysis manager 540 may transmit, retrieve, and/or store information (e.g., temperature estimates associated at least a portion of the physical structure with a time stamp) associated with the determination within specification data 512, environmental data 514, operational data 516, and/or historical data 518 according to a predefined schedule, frequency, or periodicity, or via request.

In some embodiments, the signal analysis manager 540 may implement any suitable predefined protocol set/rules to identify whether a heating event is occurring (or is likely to occur). To identify whether a heating event is occurring, signal analysis manager 540 may store or otherwise obtain one or more predefined thresholds. As a non-limiting example, signal analysis manager 540 may generate a heat pattern map from historical images of historical data 518. In some embodiments, another component of the OHS 502 may generate the heat pattern map and the signal analysis manager 540 may obtain said map from that component or from a storage location accessible to both the generating component and the signal analysis manager 540. As discussed above, a heat pattern map may be generated by averaging pixel values (or groups of pixels values) from two or more respective images (e.g., two or more infrared images of historical data 518), where each pixel represents temperatures (e.g., surface temperatures) at various location of the physical structure and/or the geographical area 200 of FIG. 2 at which the physical structure is located). In some embodiments, the signal analysis manager 540 may identify when a pixel value in a given image (e.g., a most-current infrared image) diverts from a corresponding value of the heat pattern map over a predefined threshold difference. If a current heat signature identified with one or more pixels diverts over a threshold difference form the heat pattern map (or from a corresponding pixel or group of pixels of a previously captured infrared image of historical data 518, such as a last infrared image captured prior to the current image being processed), the signal analysis manager 540 may be configured to determine that a heating event is occurring and may invoke any suitable functionality of the remedial action manager 550 to implement one or more remedial actions in response to detecting the heating event. The heating event may indicate that, based at least in part on the surface temperature and/or the one or more attributes associated with the physical structure, that a capability of a temperature control system associated with the physical structure is likely insufficient to meet a temperature control requirement associated with the physical structure.

As another example, signal analysis manager 540 may be configured to receive output(s) from model manager 530. Signal analysis manager 540 may utilize any suitable output(s) provided by model manager 530 alone, or in combination with any suitable other data (e.g., data obtained from imagery source 504, specification data 512, environmental data 514, operational data 516, historical data 518, etc.) to determine whether a heating event is likely occurring or is likely to occur. In some embodiments, the model(s) and/or the signal analysis manager 540 may be configured to predict future heating events based at least in part on historical data 518. In these examples, predicting that a heating event is likely to occur (e.g., that a capability of a temperature control system associated with the physical structure is likely to be insufficient to meet a temperature control requirement associated with the physical structure) may include determining that the heating event is likely to occur within a period of time (e.g., within the next 10 minutes, 2 hours, 2 days, or the like).

In some embodiments, the OHS 502 (e.g., the remedial action manager 550) may receive information (e.g., results from processing various signals) from the signal analysis manager 540 to determine if a remedial action may be initiated. In a non-limiting example, the remedial action manager 550 may receive one or more results from an analysis provided by the signal analysis manager 540 that may indicate that a physical structure may be experiencing a heating event. In a non-limiting example, the signal analysis manager 540 may have received a first set of infrared images from the imagery source 504 at a first frequency (e.g., once per week). The first set of infrared images may depict the same physical structure (e.g., a datacenter) or portions thereof. The signal analysis manager 540 may have determined that a first temperature at a location of the physical structure is not congruous with a historical temperature analysis (e.g., obtained from historical data 418) associated with the physical structure. In some embodiments, this determination may be based at least in part on a heat pattern map generated from historical data 418 of the datacenter. In this non-limiting example, the signal analysis manager 540 may determine a first difference between the first temperature and the historical temperature that may exceed a first temperature threshold associated with a temperature control requirement (e.g., a temperature threshold defined by either one or more of the OHS 502, a user interface, a model(s) of FIG. 6, and/or a datacenter). In response to this determination, the signal analysis manager 540 may relay information related to the first temperature threshold to the remedial action manager 550 to initiate protocols/rule sets.

In this non-limiting example, the remedial action manager 550 may implement protocols and/or rule sets to reduce potential impacts (e.g., datacenter failures, component damage, outages, and the like). In some embodiments, the remedial action manager 550 may transmit a request to the imagery source 504 to increase a frequency of captured infrared images from the first frequency to a second frequency (e.g., from once per week to once per hour or even more frequent) to produce a second set of infrared images, such that the second frequency may be higher than the first frequency. In addition, the remedial action manager 550 may transmit instructions to the input/output processing component 520 to provide a notification at a user interface. In response to the request to increase the frequency of acquired infrared images, the signal analysis manager 540 may provide a new analysis on a second set of infrared images to the remedial action manager 550. For example, the image processing component 510 may determine at least one second temperature at the location of the physical structure based on the second set of infrared images. In this example, the signal analysis manager 540 may determine at least one second difference between the second temperature(s) of the second set of infrared images and the first temperature(s) of the first set of infrared images and correlate the historical temperatures associated with the physical structure with the first temperature and/or second temperature. The signal analysis manager 540 may report to the remedial action manager 550 that the second difference(s) exceed one or more second threshold(s). In some embodiments, the remedial action manager 550 may transmit instructions to the input/output processing component 520 to provide a notification at a user interface that indicates the second difference(s). In some examples, the first difference and second difference may indicate, but are not limited to, temperature differences between one or more 1) temperature control systems (e.g., temperature control system(s) 112 including HVAC exhaust unit(s) 320 of FIG. 3) of the physical structure, 2) vehicles, 3) roofs, 4) weather patterns (e.g., environmental data 514). In some examples, the remedial action manager may transmit, retrieve, and/or store information (e.g., remedial actions) associated with the event within specification data 512, environmental data 514, operational data 516, and/or historical data 518 according to a predefined schedule, frequency, or periodicity, or via request.

In some embodiments, if the second difference is less than the first difference, or is within a predefined threshold (e.g., the same or different threshold that caused the increase in image capture), the signal analysis manager 540 may send any suitable data to the remedial action manager 550 to indicate the heating event is no longer occurring. In response, the remedial action manager 550 may transmit data to input/output processing component 520 to reduce (or return) to a lesser image capture frequency, periodicity, or schedule. In this manner, the system may increase or decrease the frequency/periodicity of images captured to verify heating events and/or rule out suspected heating events, as needed. This enables the system to utilize fewer processing resources when heating events are not suspected but increase monitoring efforts when (and potentially only when) heating events are suspected.

In some embodiments, the remedial action manager may perform, based at least in part on the infrared image analysis and/or output provided by the signal analysis manager 540, to perform or invoke, one or more (but not limited to) of the following operations 1) enforcing a power cap on one or more servers within the physical structure, 2) migrating a workload from one or more servers, 3) shutting down one or more servers, or 4) pausing one or more servers by interacting with various power distribution units of the physical structure. In some embodiments, the remedial action manager 550 may directly perform operations such as those described below, while in other embodiments, the remedial action manager 550 may transmit data to power management service 404 of FIG. 4 to effectuate one or more remedial actions.

The remedial action manager 550 (and/or the power management service 404) may be configured to receive/obtain consumption data from PDU(s) (e.g., from rack PDU 420 from a power controller such as BMC/ILOM 422 of FIG. 4) from input/output processing component 520. As described above in FIG. 4, the consumption data may be aggregated or cumulative with respect to one or more devices. As a non-limiting example, an instance of consumption data received by the OHS 502 may include the cumulative/aggregated consumption data for every device relating to (e.g., managed by) a given PDU. By way of example, the PDU providing the consumption data may be a rack PDU (e.g., rack PDU 420) and the consumption data provided by that PDU may include the cumulative/aggregated and/or individual consumption data values for every device in the rack (e.g., the hosts of host(s) 424 associated with a given rack 419). In some embodiments, the cumulative/aggregate consumption data values may additionally include a power consumption of the PDU. The remedial action manager 550 (and/or the power management service 404), from this consumption data, may access to individual and/or aggregated or cumulative power consumption data with respect to individual devices or all of the devices to which that instance of consumption data relates. The remedial action manager 550 (and/or the power management service 404) may be configured to perform any suitable operation (e.g., migrating a workload, aggregating consumption data, calculating power cap values, calculating timing values, determining budgeted power values, identifying whether power capping is needed (e.g., when aggregated consumption breaches/is likely to breach budgeted power, etc.) based at least in part on any suitable configuration data identifying the arrangement of the components within the datacenter (e.g., indicating which devices distribute power to which devices) and/or the analysis on the infrared image.

In some embodiments, the remedial action manager 550 may present a notification based on a detected difference of temperatures. By way of example, the remedial action manager 550 may receive a first set of infrared images (e.g., a few to a dozen) at a first frequency (e.g., once per day) from an imagery source 504 (e.g., satellite imager) that depict a physical structure (e.g., a datacenter). The OHS 502 (e.g., image processing component 510) may detect at least one first temperature at a first location of the physical structure based on the received first set of infrared images. In some examples, the OHS 502 may obtain historical data (e.g., from historical data 518) such as previous historical temperatures of the same physical structure or similar and determine (e.g., via the signal analysis manager 540) one or more first differences between at least one of the first temperature identified from the first infrared image and a historical temperature associated with the physical structure. In some embodiments, responsive to determining that the one or more first differences exceed a first threshold (e.g., temperature values are twenty percent smaller than previous calculated), the OHS 502 (e.g., remedial action manager 550) may increase a frequency of capturing infrared images by the imagery source 504 to a second frequency, where the second frequency may be larger/more frequent than the first frequency, to obtain a second set of infrared images. The OHS 502 (e.g., signal analysis manager 540) may detect a second temperature at the location of the physical structure based in part of a second infrared image of the second set of infrared images. In some examples, the OHS 502 may also determine a second difference between the second temperature identified from the second infrared image and the historical temperature associated with the physical structure. The OHS 502 (e.g., the signal analysis manager 540) may determine, in some non-limiting examples, that the second difference exceeds a second threshold (e.g., temperature difference has exceeded yearly averages), and perform (e.g., by remedial action manager 550) one or more remedial actions that may include, but are not limited to, 1) presenting a notification indicating the second difference at a user interface, 2) presenting an image of the physical structure indicating the location at a user interface, 3) presenting a false-color infrared image of the physical structure at a user interface, 4) presenting a notification indicating a recommendation to increase frequency of image capture at a user interface, 5) presenting a notification alerting a user to add the first difference or the second difference to historical data 518 at a user interface, 6) recommending to a user to begin data migration, 7) transmitting a recommendation to a user interface to begin power control, or similar.

In some embodiments, the OHS 502 (e.g., the image processing component 510, the signal analysis manager 540, or the like) may correlate temperatures with equipment on site at the physical structure (e.g., datacenter). For example, the OHS 502 may correlate (e.g., based on locations of the specification data 512 and relative locations indicated by the pixels of the image, based on detecting an object corresponding to an HVAC components such as an HVAC exhaust unit, etc.) the first temperature identified from the first set of infrared images and the second temperature identified from the second set of infrared images with a temperature control system of the physical structure. In some examples, the OHS 502 (e.g., remedial action manager 550) may transmit a notification to a user interface indicating that the second difference correspond to the temperature control system (e.g., a specific temperature difference at a location corresponds to a specific temperature control system such as one of the HVAC exhaust unit(s) 320).

In some embodiments, the OHS 502 (e.g., remedial action manager 550) and/or the power management service 404 may calculate aggregated/cumulative consumption data to identify aggregated/cumulative consumption data with respect to one or more devices at a higher level of power distribution hierarchy. By way of example, the OHS 502 may utilize consumption data provided by one or more rack PDUs and calculate aggregated/cumulative consumption data for a row device. For example, consumption data corresponding to devices that share a common set of row PDUs. In this case, the common set of row PDUs may represent a bus bar. In some embodiments, consumption data indicating the power consumption of the one or more rack PDUs may be included in the consumption data provided to OHS 502. The consumption data provided by the rack PDUs may be provided according to any suitable frequency, periodicity, or schedule, or in response to a request transmitted by the OHS 502. Power management service 404 may obtain consumption data relating to any suitable number of device(s) of FIG. 4 such as the host(s) 424 and/or racks of device(s) corresponding to one or more racks (e.g., rack 419) and may aggregate or calculate any suitable consumption data corresponding to any suitable number of components.

The OHS 502 (e.g., the remedial action manager 550) and/or the power management service 404 may be configured to calculate one or more power caps (e.g., power cap values for one or more servers to which power is distributed by a higher-level device (e.g., in this example, a row-level device) based at least in part on allocated power values (e.g., an amount of budgeted power) for that higher-level component. The higher-level component may correspond to any suitable level (e.g., levels 2-5 in a power distribution hierarchy) of the power distribution other than the lowest level (e.g., level 1 in the power distribution hierarchy). By way of example, the OHS 502 and/or the power management service 404 may calculate power cap values for servers to which power is distributed by a given row device (e.g., a bus bar). These calculations may be based on consumption data provided by the rack PDUs to which power is distributed by the row device. In some embodiments, the OHS 502 and/or the power management service 404 may store consumption data for subsequent use. The OHS 502 and/or the power management service 404 may utilize historical consumption data when calculating these power cap values. In some embodiments, the OHS 502 and/or the power management service 404 may obtain, utilize, and/or train one or more machine-learning models to identify, from historical data 518, particular power cap values for one or more host(s) 424 (e.g., components corresponding to level 1 of the power distribution hierarchy).

The OHS 502 (e.g., the remedial action manager 550) and/or the power management service 404 may calculate a timing value for a timer (e.g., a timer that may be initiated and managed by the PDU(s) such as rack PDU 420). The timing value may be calculated based at least in part on any suitable combination of: a rate of change in the power consumption of a higher-level component, a direction of change (increasing/decreasing) of the power consumption of the higher-level component, a power spike tolerance of the higher-level component and/or of the detection system 400 as a whole, or an enforcement time associated for lower-level devices (e.g., a presumed/known delay between when each of the device(s) (e.g., host(s) 424) are instructed to enforce power cap values and when each of device(s) (e.g., host(s) 424) will be actively enforcing the cap (e.g., a first time at which power consumption at that device is constrained/throttled, or at least a determination of whether to constrain/throttle is made).

The OHS 502 (e.g., the remedial action manager 550) and/or the power management service 404 may communicate calculated timing values to the rack PDU(s) 420 at any suitable time. In some embodiments, the OHS 502 and/or the power management service 404 may initially determine power caps for a given higher-level component (e.g., a row component) without regard to consumption occurring with respect to other components of the same level (e.g., other row components). In some embodiments, while the timer is being initialized or elapsing, or at any suitable time, the OHS 502 and/or the power management service 404 may process consumption data corresponding to other same-level components to determine if power capping downstream components of one or more of those same-level components is more desirable. In some embodiments, the OHS 502 may utilize a priority associated with the device(s) and/or the workloads running on those device(s) to determine power cap values (e.g., a priority identified based at least in part on host/instance data 424/426 of FIG. 4). The OHS 502 and/or the power management service 404 may be configured to favor power capping lower-priority device(s)/workload(s) while leaving device(s)/workload(s) with higher priority values unconstrained. In some embodiments, OHS 502 and/or the power management service 404 may be configured to favor power capping a set of highest consuming devices (e.g., across one row, across rows, etc.) while leaving lower consuming devices to operate unconstrained. In some embodiments, the particular consumption of one device, even if the device is included in the set of highest consuming devices, may be left unconstrained if the priority associated with that device and/or workload is high (or higher than priorities associated with other devices and/or workloads). Thus, the OHS 502 and/or the power management service 404 may be configured to prioritize the priority of the device/workload over the power consumption of that particular device.

In some embodiments, power cap values may be initially determined by the OHS 502 (e.g., by the remedial action manager 550) and/or the power management service 404 for a given row. Those power cap values may be provided to the power controller of the rack PDU (e.g., the BMC/ILOM 428, or another agent or component of the rack PDU 420) which, in turn, may distribute the power cap values to the power controller (e.g., the BMC/ILOM 428) at the host(s) 424 for storage. The OHS 502 (e.g., the remedial action manager 550) and/or the power management service 404 may process consumption data with respect to other row devices of the same row to determine power cap values for devices corresponding to different row. This may be advantageous since devices managed by another row may not be consuming their budgeted power, leaving some amount of power unutilized at that row-level device. In some embodiments, the OHS 502 (e.g., the remedial action manager 550) and/or the power management service 404 may be configured to determine whether power capping the devices of one row, while allowing at least some devices of another row to operate unconstrained may be more advantageous. Determining a benefit for a set of power cap values may be based at least in part on minimizing an estimated impact (e.g., a number of devices to be power capped), minimizing priority values associated with the devices to be power capped, maximizing the number of devices associated with particular high priority values that will not be power capped, and the like. The OHS 502 and/or the power management service 404 may utilize a predefined protocol (e.g., a set of rules) to determine whether enforcement of the power cap values it already sent to one PDU is more or less advantageous/beneficial than different power capping values it has identified based on processing consumption data from multiple PDUs associated with one or more other rows.

The OHS 502 (e.g., the remedial action manager 550) and/or the power management service 404 may be configured to enact the enforcement of the set of power cap values that are determined to be most advantageous (based on the protocols/set of rules) to ensure that one or more circuit breakers within the datacenter are not tripped and/or that an aggregate power threshold is enforced. If current/aggregate power consumption levels exceed the current aggregate power threshold, the OHS 502 and/or the power management service 404 may be configured to execute or trigger execution of operations to bring the current/aggregate power consumption levels to a value that falls below the current aggregate power threshold.

In some embodiments, the OHS 502 and/or the power management service 404 may be configured to identify power cap values and/or enforce power cap values based at least in part on instructions and/or constraints or other applicable data provided by OHS 502. As a non-limiting example, the OHS 502 and/or the power management service 404 may filter aggregated data of any suitable combination of imagery source 504 data, the specification data 512, the environmental data 514, the operational data 516, historical data 518, based on a reduction action associated with a level (e.g., “power cap by 10% all low priority hosts.”) to determine the estimated impact of implementing the action, including the number and/or subset of resources (e.g., hosts, instances, workloads, customers) to which the action, if implemented, applied. By way of example, the OHS 502 and/or the power management service 404 may identify from aggregated data of any suitable combination imagery source 504 data, the specification data 512, the environmental data 514, the operational data 516, historical data 518, the number and/or identifiers corresponding to all low-priority hosts. In some embodiments, the identifiers and/or the instruction (power cap by 10%) may be provided to the OHS 502 and/or the power management service 404 received through the input/output processing component 520 and implemented by the remedial action manager 550. As another non-limiting example, any suitable portion of the metadata associated with the reduction action (e.g., “power cap by 10% all low priority hosts”) may be provided to the OHS 502 and the remedial action manager 550 (and/or the power management service 404) may be configured to identify the particular hosts/instances/workloads from the metadata associated with the reduction action. Said another way, any suitable combination of the OHS 502 and/or the power management service 404 may be configured to identify the estimated impact of a given action. In some embodiments, the OHS 502 (e.g., remedial action manager 550) and/or the power management service 404 may be configured to identify, given the hosts/instances/workloads/customers expected to be impacted if the action (or level) is effectuated, an estimated power reduction value corresponding to an individual or aggregate power consumption of one or more device(s) (e.g., host(s) 424).

If the set of power caps previously provided to power controller (e.g., BMC/ILOM 422 and/or BMC/ILOM 422) is determined to be most advantageous, the OHS 502 may transmit data to the power controller to cause the power controller to transmit the indicator to device(s) to commence power capping based on the previously distributed power caps. Alternatively, if the OHS 502 and/or the power management service 404 determines the new set of power caps are more (or most) advantageous from a power management perspective, it may transmit data to the power controller (e.g., BMC/ILOM 422) to cancel the timer. In some embodiments, canceling the timer may cause the previously distributed power caps to be deleted by instruction from the power controller (e.g., transmitted in response to canceling the timer), or those power caps may time out by default (e.g., according to a predefined time period). OHS 502 and/or the power management service 404 may transmit the new power caps to the appropriate PDUs (which may include or exclude the same PDU to which the previous set of power caps was transmitted) with an indication that the power caps are to be immediately enforced by the corresponding devices. These PDUs may transmit those power caps with an instruction to the receiving device to immediately commence power capping operations (e.g., including monitoring consumption with respect to the power cap value, determining whether the cap based on the power cap value and current consumption of the device, and cap or leave unconstrained the operations of the device based on the determination).

In some embodiments, if the timer expires at the original PDU (e.g., a time period corresponding to the timing value elapses), and a cancellation from the OHS 502 has not been received, the power controller (e.g., BMC/ILOM 422) may automatically instruct the device(s) (e.g., via BMC/ILOM 428) to commence power capping operations with the power cap values stored. This technique ensures a failsafe for when, for any reason, the OHS 502 and/or the power management service 404 fails to instruct the PDU or cancel the timer.

In some embodiments, monitoring, identifying, and/or constraining based on power cap values (as described above) may be determined by the OHS 502 and/or the power management service 404 directly based on data from, but not limited to, the signal analysis manager 540, the model manager 530, the images from imagery source 504, the specification data 512, the environmental data 514, the operational data 516, historical data 518, and the like.

It should be appreciated that image data from imagery source 504, specification data 512, environmental data 514, or operational data 516 may include current data indicating current values and/or historical data 518 indicating corresponding historical values. In some embodiments, future attributes of specification data 512, environmental data 514, or operational data 416, may be predicted based at least in part on the historical data 518 or historical data pulled from another suitable data source such as the Internet. In some embodiments, machine learning may be utilized to predict any suitable portion of these future attributes. Example methods for predicting future values for specification data 512, environmental data 514, or operational data 516, are discussed in more detail with respect to FIG. 6. In some embodiments, the OHS 502 may be configured to aggregate the data of any suitable combination of image data from imagery source 504, specification data 512, environmental data 514, operational data 516, or historical data 518 into a table, mapping, or database from which the data may be filtered or sorted to identify a subset of resources (e.g., hosts, instances, workloads, customers) for a given set of constraints (e.g., low-priority workloads, free tier customers, etc.).

FIG. 6 illustrates a flow depicting an example method 600 for training one or more machine-learning models, in accordance with at least one embodiment. In some embodiments, the model(s) 602 may be trained (e.g., by monitor and detector system 400 of FIG. 4, the OHS 402 of FIG. 4, the compute service 406 of FIG. 4, or a different device or system) using any suitable machine-learning algorithms (e.g., supervised, unsupervised, etc.) and any suitable number of training data sets (e.g., training data 608). A supervised machine-learning algorithm refers to a machine learning task that includes learning an inferred function that maps an input to an output based on a labeled training data set for which example input/output pairs are known. Unsupervised machine-learning algorithms refer to a set of algorithms that are used to analyze and cluster unlabeled data sets (e.g., unlabeled data 610). These algorithms are configured to identify patterns or data groupings without the need for human intervention. In some embodiments, any suitable number of model(s) 602 may be trained during training phase 604.

At least one model of model(s) may be trained to identify a likelihood or confidence of identifying a potential issue associated with a physical structure, in accordance with at least one embodiment. The training data 608 for training one or more of model(s) 602 may include any suitable combination of individual and/or aggregate image data values (current or historical) of image data from imagery source 504. In some embodiments, the training data 608 for training these particular model(s) 602 may include any suitable combination of image data from imagery source 410, specification data 512, environmental data 514, operational data 516, and/or historical data 518. In some embodiments, the model(s) may be trained to identify objects (e.g., structures, vehicles, construction, repair components, and the like), heat sources (e.g., HVAC systems), other items of interest (e.g., weather pattern changes), or any suitable combination thereof.

At least one model of model(s) may be trained to implement any suitable object detection techniques to identify one or more objects from an image, in accordance with at least one embodiment. The training data 608 for training one or more of model(s) 602 to identify objects that may include any suitable combination of data including, but not limited to, 1) physical structures schematics and/or images, 2) images and/or schematics of vehicles (e.g., vehicles depicted in proximity to a physical structure), 3) images and/or schematics of equipment (e.g., repair equipment) that may be depicted near a physical structure, or the like. In some embodiments, the training data 608 for training these particular model(s) 602 may include any suitable combination of image data from imagery source 504, specification data 512, environmental data 514, operational data 516, and/or operational data 516.

In some embodiments, the model(s) 602 may be any suitable recurrent convolutional neural network, convolutional neural network, or the like. In some embodiments, model(s) 602 may include a two-stage architecture where a first stage corresponding to a first model identifies candidate regions and a second stage corresponding to a second model identifies object(s) within the candidate region. In some embodiments, one or more of the model(s) may be trained to classify objects based on training data comprising images of objects for which a classification is known. The model(s) 602 may be used to segment an image into candidate region, where each region is then classified as depicting or not depicting one or more of a set of known objects. By way of example, the model(s) 602 may be trained on images depicting, among other things, vehicles, HVAC exhaust units, HVAC units, power supply units, power distribution units, repair components and/or equipment, or the like. Once trained, an image can be provided as input to the model(s) 602. One model may identify candidate regions within the image which may be used as input to a second model that may be trained to identify one or more objects within the candidate region. In this manner, the model(s) 602 may be used to identify aspects of the physical building, portions of HVAC units, power distribution equipment, construction, vehicles, repair components and/or equipment, or the like.

At least one model of model(s) may be trained to identify predicted partial or complete failures of one or more temperature control units based on infrared images, in accordance with at least one embodiment. The training data 608 for training one or more of model(s) 602 to identify such failures may include any suitable combination of current and/or historic data of environmental data 514 and/or operational data 516 corresponding to the physical location in which the host(s) 324 and/or server(s) 104 are located, current and/or historic external temperatures occurring currently or in the past with respect to an area outside of the physical environment (e.g., in the geographical area in which the physical environment is located), current and/or historic ambient locations associated with the physical location, weather forecasts corresponding to a future time period, and current and/or historic failures experienced by one or more temperature control units (e.g., temperature control system(s) 112 including HVAC exhaust unit(s) 320 of FIG. 3). In some embodiments, the training data 608 for training these particular model(s) 602 may include any suitable combination of image data from imagery source 504, specification data 512, environmental data 514, operational data 516, and/or historical data 518. In some embodiments, the model(s) may be trained (e.g., using supervised and/or unsupervised learning algorithms) to identify a likelihood or confidence that a particular failure (partial or complete) of a temperature control system (e.g., one or more of temperature control system(s) 112 of FIG. 1) will occur during a future time period. In some embodiments, the model(s) may be trained to identify a degree of failure for the temperature control system(s) (e.g., 80% failure, 100% failure, etc.).

At least one model of the model(s) may be trained to identify and/or predict a behavior of one or more physical structures based on historical data over a time period (e.g., from a few hours to a few years). The historical data comprising any suitable combination images (e.g., from imagery source 504), objects detected within those images, specification data 512, environmental data 514, operational data 516, and/or historical data 518. For example, the model(s) may be trained to identify, from one or more images with infrared heat signatures, changes in emissions over the time period. In a non-limiting example, an imaged physical structure in Spring may have a first profile along with various operating conditions (e.g., operating capacity, load, etc.). The same physical structure may have a second profile in Summer compared to Spring. Over the time period, the model(s) may be trained to determine a health score (e.g., similarity score) for the physical structure to enable comparisons to newer infrared images. For example, the model(s) that generate the health score may include one or more metrics such as, but not limiting to, 1) average temperature readouts, 2) temperature profiles during weather events (e.g., rain, high wind), 3) temperature profiles during extreme temperature shifts (e.g., warm fronts, cold fronts, etc.), 4) physical structure changes (e.g., additional temperature control units added or removed), 5) temperature profiles during seasons, 6) temperature profiles during maintenance periods (e.g., which temperature control units are shut down and how often for maintenance), 7) historical downtime (e.g., an average on/off time for each temperature control unit), 8) power draw for servers within the physical structure, 9) government mandates (e.g., power limiting based on policies), 10) a behavior identifier (e.g., “healthy”, “not healthy”) or similar.

At least one model of model(s) may be trained to provide an estimated aggregate power reduction needed due to a partial and/or complete failure of one or more temperature control units (e.g., temperature control system(s) 112 including HVAC exhaust unit(s) 320 of FIG. 3), in accordance with at least one embodiment. The training data 608 for training one or more of model(s) 602 to identify estimated aggregate power reduction needed may include any suitable combination of current and/or historic data of environmental data 514 and/or operational data 516 corresponding to the physical location in which the host(s) 424 and/or server(s) 104 are located, current and/or historic external temperatures occurring currently or in the past with respect to an area outside of the physical environment (e.g., in the geographical area in which the physical environment is located), current and/or historic ambient locations associated with the physical location, weather forecasts corresponding to a future time period, current and/or historic failures experienced by one or more temperature control units (e.g., temperature control system(s) 112 including HVAC exhaust unit(s) 320 of FIG. 3), current and/or historic aggregate power thresholds, and/or current and/or historic power consumption levels of the host(s) 424 and/or any suitable combination of the server(s) 104. In some embodiments, the training data 608 for training these particular model(s) 602 may include any suitable combination of image data from imagery source 504, specification data 512, environmental data 514, operational data 516, and/or historical data 518. In some embodiments, the model(s) may be trained to identify a likelihood or confidence that the estimated aggregate power reduction will be needed during a future time period.

At least one model of model(s) may be trained to predict a future temperature (e.g., ambient and/or external), in accordance with at least one embodiment. The training data 608 for training one or more of model(s) 602 to identify the future temperature may include any suitable combination of current and/or historic data of environmental data 514 and/or operational data 618 corresponding to the physical location in which the host(s) 324 and/or server(s) 104 are located, current and/or historic external temperatures occurring currently or in the past with respect to an area outside of the physical environment (e.g., in the geographical area in which the physical environment is located), current and/or historic ambient locations associated with the physical location, weather forecasts corresponding to a future time period, current and/or historic failures experienced by one or more temperature control units (e.g., the temperature control system(s) 112 of FIG. 1), current and/or historic aggregate power thresholds, and/or current and/or historic power consumption levels of the host(s) 324 and/or any suitable combination of the server(s) 104. In some embodiments, the training data 608 for training these particular model(s) 602 may include any suitable combination of image data from imagery source 504, specification data 512, environment data 514, operational data 516, and/or historical data 518. In some embodiments, the model(s) may be trained to identify a likelihood or confidence that the predicted temperature will be experienced during the future time period.

In general, the model(s) 602 may include any suitable number of models. The model(s) 602 may be individually trained to identify, from the training data 608 discussed above, a likelihood or confidence or accuracy of the output provided by model(s) 602. In some embodiments, the model(s) 602 may be configured to determine a value corresponding to the examples provided above, and the likelihood and/or confidence value may indicate a likelihood or degree of confidence that the output provided by the model(s) is accurate.

In general, the model(s) 602 can be trained during training phase 604 using a supervised learning algorithm and labeled data 606 to identify outputs described in the examples above. A likelihood value may be a binary indicator, a percentage, a confidence value or the like that indicates a degree of likelihood. The likelihood value can be a binary indicator that indicates a particular budget amount is likely or unlikely to be breached, or the likelihood value can indicate a likelihood and/or confidence that the predicted output will be experienced in the future. Labeled data 606 may be any suitable portion of potential training data (e.g., training data 608) that can be used to train model(s) to produce the output described above. Labeled data 606 may include any suitable number of examples of current and/or historical data corresponding any suitable number of devices of the physical environment (e.g., datacenter 102, server(s) 104, temperature control system(s) 112, PDUs of FIG. 2, etc.). In some embodiments, labeled data 606 may include labels that identify known likelihood and/or actual values. Using the labeled data 606, a model (e.g., an inferred function) may be learned that maps an input (e.g., one or more instances of training data) to an output (e.g., a predicted value or likelihood/confidence value that the predicted value or output will occur in a future time period). In some embodiments, any suitable combination of the OHS 402 (e.g., the model manager 530), power management service 404, and/or the compute service 406 of FIG. 4, or a separate service or system may train any suitable combination of the model(s) 602. In some embodiments, any suitable combination of the OHS 502, power management service 404, and/or the compute service 406 may obtained pretrained versions of the model(s) 602.

At least one model of the model(s) may provide a status label (e.g., health status) associated with an operational status or attribute of one or more components associated with the physical structure. By way of example, the OHS 502 may receive and process (e.g., by image processing component 510 of FIG. 5) an infrared image depicting an aerial view of a physical structure (e.g., a datacenter) and retrieve operational data (e.g., retrieved from operational data 516 of FIG. 5) associated with a temperature control system (e.g., temperature control system(s) 112 including HVAC exhaust unit(s) 320) identified in the infrared image. The OHS 502 may provide the operational data and the infrared image to one or more of the model(s) 602 as an input. In some examples the model(s) have been previously trained (e.g., using training data 608 including labeled data 606 and/or unlabeled data 610 including any suitable combination of image data from imagery source 504, objects detected with each image of the image data, specification data 512, environment data 514, operational data 516, and/or historical data 518) to identify whether the temperature control system is likely operation at a reduced capacity from at least one instance or portion of the operational data and a corresponding image provided as the input. In some embodiments, the model(s) output may be transmitted or otherwise obtained by the OHS 502 (e.g., the signal analysis manager 540 of FIG. 5) to execute one or more operations based at least in part on the results (e.g., output) provided by the model(s). By way of example, the model(s) may be trained based at least in part on a supervised machine learning-algorithm and labeled data set (e.g., such as historical data associated with the same or a different datacenter). The labeled data set may include, but is not limited to, 1) operational data instances, 2) one or more corresponding infrared images 3) objects detected within the one or more corresponding infrared images, 4) a heat pattern map generated from one or more corresponding images of a physical location, 5) one or more labels indicating an operational status of one or more components associated with the physical structure (e.g., one or more HVAC units), 4) one or more attributes of one or more components associated with the physical structure as identified by the specification data 512, 5) labels associated health (e.g., behaving normally, behaving abnormally, etc.).

In some embodiments, at least one model of the model(s) 602 may provide indications on one or more physical structures over time. By way of a non-limiting example where images are captured by a satellite at a first frequency (e.g., a few times per week), the model(s) may develop (e.g., by way of training phase 604) characterization maps for one or more physical structures being images. For example, a datacenter may be imaged a few times a week in spring and had four scheduled maintenance periods which were each imaged and stored in historical data 518 of FIG. 5. The model(s) may track what the datacenter looked like by way of infrared imaging and object detection algorithms. Said another way, the model(s) 602 may be classification models that identify a degree of similarity between historical images/objects detected within historical images and a current image/object(s) detected within the current image. In summer, the datacenter may continue to be imaged and the maintenance periods may also be tracked. As seasons progress, the model(s) may continue to add more attributes to the historical data to develop a first characterization map (e.g. a map comprising typical (e.g., average) heat emission values corresponding to various locations of and near the building 202 of FIG. 2, objects locations and identifiers identifying object and corresponding object locations within historical images, and the like) for the datacenter which may help determine what may be considered “normal” operations and “abnormal operations” by comparison. For example, if the datacenter had no issues in the summer of 2022, but had a temperature control unit fail in the summer of 2023, one or more of the model(s) 602 may be able to note the difference in the infrared images and may store the images for future comparisons (e.g., such as determining if repair equipment was present in the image, if a new piece of equipment was installed, or similar). Over time (e.g., months to decades) the model(s) may develop any number of suitable characterization maps for one or more structures to determine a difference between a “normal” operation and an “abnormal” operation. In some examples, the model(s) may transmit, retrieve, and/or store information associated with the characterization maps within specification data 512, environmental data 514, operational data 516, and/or historical data 518 according to a predefined schedule, frequency, or periodicity, or via request.

At least one model of model(s) 602 may be trained identify a likelihood or confidence score that the physical structure or components of the physical structure experience a one or more heating events. By way of example, the model(s) 602 may utilize the characterization maps, heat pattern maps, of one or more physical structures to determine if certain events are likely to cause disruptions to servers or power relating to the physical structure. As a non-limiting example, the model(s) 602 may utilize weather data indicating an impending hurricane to identify a likelihood that the physical structure and/or components of the physical structure may experience a power outage. In some examples, the model(s) may provide a confidence score associated with historical data 518 and severe weather events to enable data migration (as discussed above) prior to the severe weather event. The pre-emptive data migration may serve to lower the load experienced by servers thereby lowering the required power needed to be supplied by the external generators. By way of another example, some geographically specific areas that contain datacenters may have unique wind patterns or topologies which give rise to unique situations. In some examples, the model(s) 602 may serve to utilize any suitable combination of image data (e.g., including images and/or objects detected within those images) from imagery source 504, specification data 512, environmental data 514, operational data 516, historical data 518, etc. to generate “best fit” categories for new physical structures that have been imaged for the first time as a starting point for generation of more robust characterization maps. In a non-limiting example, the model(s) 602 may also be used to generate predictions for geographical areas that do not yet have physical structures to identify potential issues a datacenter may experience if built in that or similar geographical areas.

The model(s) 602, and the various type of those models discussed above, may include any suitable number of models that are trained using unsupervised learning techniques to identify the likelihood/confidence and/or a predicted amount corresponding to the examples provided above. Unsupervised machine-learning algorithms are configured to learn patterns from untagged data. In some embodiments, the training phase 604 may utilize unsupervised machine-learning algorithms to generate one or more of the model(s) 602. For example, the training data 608 may include unlabeled data 610 (e.g., any suitable combination of current and/or historic values corresponding to image data from imagery source 504, specification data 512, environmental data 514, host/instance data, operational data 516, historical data 518, etc.). Unlabeled data 610 may be utilized, together with an unsupervised learning algorithm to segment the entries of unlabeled data 610 into groups. The unsupervised learning algorithm may be configured to cause similar entries to be grouped together in a common group. An example of an unsupervised learning algorithm may include clustering methods such as k-means clustering, DBScan, and the like. In some embodiments, the unlabeled data 610 may be clustered with the labeled data 606 such that unlabeled instances of a given group may be assigned the same labeled as other labeled instances within the group.

In some embodiments, any suitable portion of the training data 1208 may be utilized during the training phase 604 to train the model(s) 602. For example, 70% of labeled data 606 and/or unlabeled data 610 may be utilized to train the model(s) 602. Once trained, or at any suitable time, the model(s) 602 may be evaluated to assess their quality (e.g., the accuracy of output(s) 612 with respect to the labels corresponding to labeled data 606). By way of example, a portion of the examples of labeled data 606 and/or unlabeled data 610 may be utilized as input to the model(s) 602 in order to generate output(s) 612. By way of an example, an example of the labeled data 606 may be provided as input, and the corresponding output (e.g., output(s) 612) may be compared to the label already known to be associated with the example. If some portion of the output (e.g., a label) matches the example label, that portion of the output may be deemed accurate. Any suitable number of labeled examples may be utilized, and a number of accurate labels may be compared to the total number of examples provided (and/or the total number of labels previously identified) to determine an accuracy value for a given model that quantifies a degree of accuracy for the model. For example, if 90 out of 100 of the input examples generate output labels that match the previously known example labels, the model being assessed may be determined to be 90% accurate.

In some embodiments, as the model(s) 602 are utilized for subsequent inputs, the subsequent output generated by the model(s) 602 may be added to corresponding input and used to retrain and/or update the model(s) 602 at 616. In some embodiments, the example may not be used to retrain or update the model until feedback procedure 614 is executed. In feedback procedure 614 the example (e.g., an example including one or more historical consumption data instances corresponding to one or more devices and/or racks) and the corresponding output generated for the example by one of the model(s) 602 is presented to a user and the user identifies whether the output generated (e.g., amount and/or likelihood confidence value) is correct for the given example.

The training process depicted in FIG. 6 (e.g., method 600) may be performed any suitable number of times at any suitable interval and/or according to any suitable schedule such that the accuracy of the model(s) 602 are improved over time.

In some embodiments, any suitable number and/or combination of the model(s) 602 may be used to determine output. In some embodiments, the OHS 502 may utilize any suitable combination of output provided by the model(s) 602 to determine whether a potential issue(s) related to temperature variations of one or more objects has or will occur regarding a physical structure (e.g., datacenter). Thus, in some embodiment, models that have trained with any suitable combination of supervised and unsupervised learning algorithms may be utilized by the power management service 404.

FIG. 7 is a schematic of an example user interface 700, in accordance with at least one embodiment. User interface 700 (an example of the user interface(s) 408 of FIG. 4) may include any suitable number and type of graphical interface elements (e.g., drop down boxes, edit boxes, radio buttons, menu options, etc.) to select and/or view datacenter health data corresponding to a given building (datacenter), environmental around a building, and/or a room, respectively. The datacenter health data presented at user interface 700 may correspond to the a given building (e.g., a datacenter), the environment surrounding a building, and/or a room selected via the graphical interface elements.

As discussed above any suitable information utilized by the OHS 502, the power management service 404, and/or the compute service 406 may be presented via user interface 700. As a non-limiting example, any suitable combination of infrared images from imagery source 504, the imaging source 504 data, the specification data 512, the environmental data 514, operational data 516, and/or the historical data 518 may be presented in user interface 700.

The particular content of the user interface 700 displayed at user interface 700 may vary, but as depicted the user interface 700 may include a snapshot 702 of an infrared image (e.g., an image obtained from imagery source 504 of FIG. 5) relevant to the particular datacenter for which an image was captured. In some examples, the snapshot 702 may include a highlighted region 703 to draw attention to a potential issue such as a piece of equipment on the datacenter malfunctioning in the highlighted region 703. Highlighted region 703 may correspond to one or more objects detected within the image, one or more areas identified as including temperatures outside of a predefined threshold, or the like.

The particular content of the datacenter health data 709 displayed at user interface 700 may vary, but as depicted the datacenter health data 709 includes room identifier(s) 710, heat signature(s) 708 for the room(s) corresponding to the room identifier(s) 710, historical average heat signatures for the rooms corresponding to the room identifier(s) 710, planned maintenance data 714 (e.g., planned maintenance associated with the physical structure and/or particular components such as temperature control system 112A of FIG. 1), potential issues 716 data, and options 720. In addition, in a non-limiting example, the user interface 700 may display meteorological data 713 that may include, but is not limited to, temperature, cloud coverage, precipitation, humidity, and wind speed and direction. Meteorological data 713 may be obtained from environment data 514 of FIG. 5.

The user interface 700 may be configured to present one or more potential issues 716 (e.g., a message relating to whether one or more temperature control system(s) may be operating at a reduced capacity or malfunctioning). In some embodiments, the area corresponding to a row of the potential issue 716 may be selectable to present an expanded view of the identified issue data.

Selecting options 720 may cause options related to viewing additional historical images and/or navigating to one or more additional user interfaces at which one or more remedial actions may be identified and/or selectable. In some embodiments, button 721 may be selected to contact a manager associated with the HVAC X227 (e.g., the temperature control system associated with room 1, the room currently depicted at 722 as being selected). Similarly, button 723 may be selected to contact maintenance personal (e.g., a maintenance department associated with the temperature control system of room 1). In some embodiments, selecting buttons 721 and/or 723 may provide an email, text message, or any suitable electronic signal or communication to be provided to the identified manager/department/contact.

Although the rate/frequency of image capture may be modified by the system, as discussed above, in some embodiments, user interface 700 may include a rate adjustment button 711 that indicates an adjustment to a rate of image sampling by imagery source 504. As discussed above, the rate adjustment may be based on the factors described above and may increase or decrease the rate of image sampling. In some embodiments, the user may select option 724 to manually increase the capture rate/frequency or option 726 to manually decrease the image capture rate/frequency. These changes may be enacted until the system automatically modifies the rate/frequency, for a predetermined period of time, or until further user input is received at option 724 or option 726. In some embodiments, selection of options 724 or 726 may serve as a manual override (at least for a predetermined period of time) of the previously utilized capture frequency selected by the system. Any updates initiated through selection of options 724 and/or 726 may cause the current rate to be update according to the selection.

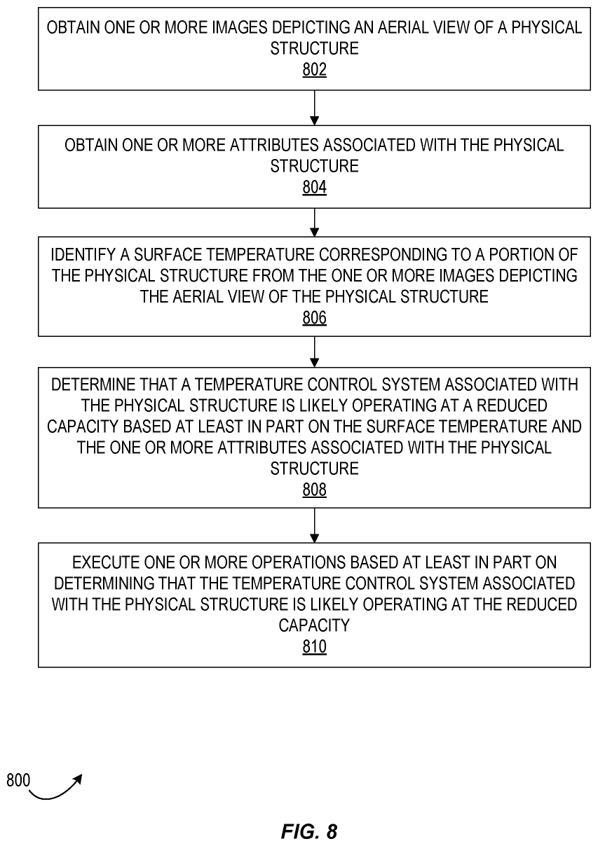

FIG. 8 is a block diagram illustrating an example method 800 for detecting a heating event (e.g., a likelihood that a capability of a temperature control system is likely insufficient to meet a temperature control requirement), in accordance with at least one embodiment. The method 800 may be performed by one or more components of monitoring and detection system 400 of FIG. 4 or subcomponents thereof discussed in connection FIGS. 5 and 6. By way of example, the method 800 may be performed, at least in part, by any suitable combination of the OHS 402, the power management service 404, and/or compute service 306 of FIG. 4. In some embodiments, the method 800 may include more or fewer steps than the number depicted in FIG. 8. It should be appreciated that the steps of method 800 may be performed in any suitable order.

The method 800 may begin at 802, wherein one or more images (e.g., infrared image 300) depicting a view (e.g., an aerial view) of a physical structure may be obtained (e.g., by imagery source 504 of FIG. 5). In some embodiments, the one or more image(s) may comprise infrared heat maps and/or temperature intensity maps of the physical structure and a surrounding environment. In some embodiments, the image(s) may include a visible spectrum component or any suitable spectrum component that is capable of aiding in identification of objects within the image(s). By way of example, the one or more image(s) may be captured by a satellite or drone or a constellation of two or more satellites and/or a set of drones. In various embodiments, the one or more image(s) may be captured by any suitable imagery source capable of capturing images of the physical structure and the surrounding environment.

At 804, one or more attributes (e.g., surface temperature of HVAC unit(s) 320 of FIG. 3) associated with the physical structure (e.g., a datacenter) may be obtained. In some embodiments, the attribute(s) may include attribute(s) associated with, but not limited to, equipment such as roof chillers (e.g., temperature control system) that cool rooms within the physical structure, dimensions and/or layout of the physical structure, identifiers and/or locations corresponding to temperature control systems and/or components of temperature control systems, planned maintenance and/or repair activities corresponding to one or more components of the physical structure, vehicles (e.g., repair vehicle 350) that function to aid the physical structure during operations, emergency cooling trailers (e.g., emergency cooling trailer 352) that may aid in cooling the physical structure during maintenance periods or similar, substation temperatures (e.g., transformer 212 of FIG. 2), power system heat emissions (e.g., power systems 210) which generate heat during operations, or repair equipment (e.g., repair equipment 354 of FIG. 3) used in maintenance operations of the physical structure.

At 806, a surface temperature may be identified that may correspond to a portion of the physical structure (e.g., datacenter) from the one or more image(s) depicting the aerial view of the physical structure. For example, the image processing component 510 of FIG. 5 may use any suitable technique to analyze the infrared spectrum of the one or more image(s). In this example, one or more heat maps of temperature distributions across the physical structure and surrounding environment may be generated for identification of potential issues associated with the physical structure. In some embodiments, a heat map may include fewer values than the pixels of the image. In some embodiments, pixels of the image may be grouped an averaged to produce a heat map that includes fewer values, but which may still be used to identify surface temperatures (e.g., average surface temperature of a predefined number of pixels proximate to a central pixel). This may reduce the computational burden of comparing heat map values of one heat map to a heat map generated from historical images. The image processing component 510 may process the image(s) to identify one or more surface temperature “hot spots” of interest. In some embodiments, these hot spots may relate to areas of the image that depict heat values that differ from an expected value (e.g., a corresponding value of a historical heat map, a heat value identified from a previously received and processed infrared image, etc.) by a predetermined threshold amount.

At block 808, in a non-limiting example, the signal analysis manager 540 (or any suitable subcomponent or component of FIGS. 4-6) may determine that a temperature control system (e.g., HVAC unit(s) 320 of FIG. 3) associated with the physical structure (e.g., building 202) is likely operating at a reduced capacity based at least in part of the surface temperature and the one or more attributes associated with the physical structure. For example, during a hot day (e.g., forty-one degrees Celsius) a datacenter may be operating at maximum capacity causing each temperature control unit on the roof to operate at maximum capacity to manage temperatures in one or more rooms within the datacenter. Due to environmental factors such as the temperature, the temperature control units which may be placed in relatively close proximity may operate at a reduced capacity due to not being able to efficiently remove heat from the datacenter quickly enough to maintain ambient temperatures within the physical structure that meet a temperature control requirement (e.g., a requirement that ambient temperatures within a room do not exceed a predefined threshold). As a result, the reduced capacity may cause one or more rooms to heat up from the heat emitted from the servers (e.g., server(s) 104 of FIG. 1) which is visible to the satellite which images datacenter. In some embodiments, the signal analysis manager 540 may determine from the image that one or more of the temperature control units is operating at reduced capacity due to the increase in surface temperatures at a location of the physical structure.

In some embodiments, identifying that a capability of a temperature control system is likely insufficient to meet a temperature control requirement associated with the physical structure may be performed using feedback from the model manager 530 (e.g., using output from model(s) 602 which may indicate actual or predicted heat events). In some embodiments, once a hot spot is identified from heat values derived from the image, the model(s) 602 may be used to reduce false positives. Therefore, in some embodiments, a hot spot may be verified using the input data and model(s) 602 described above to verify that a hot spot is actually indicative of a heating event. In some examples, the signal analysis manager 540 may receive any suitable data from one or more of the image processing component 510 and the model manager 530, and/or any suitable combination of imagery source 504, specification data 512, environmental data 514, operational data 516, and/or historical data 518 to make a determination as to whether a heating event is likely being experienced and/or is likely to be experienced (e.g., within a particular future time period).

At block 810, in a non-limiting example, the remedial action manager 550 may execute one or more operations based at least in part on determining that the temperature control system associated with the physical structure is likely operating at the reduced capacity. For example, the remedial action manager 550 (which may be invoked by the signal analysis manager 540 due to the determination that a heating event is occurring or is predicted to occur within a future time period) may implement protocols and/or rule sets to reduce potential impacts to customers that use and store data within the datacenter which is experiencing a potential issue. In some examples, the protocols may include increasing a frequency of image capture by the satellite. In this example, the frequency of image capture may increase from once every three hours to once every ten minutes or higher. In some embodiments, the remedial action manager 550 may provide one or more notifications to a graphical user interface (e.g., GUI 700 of FIG. 7) to enable a user to quickly understand the nature of the potential issue.

As discussed above, the remedial action manager 550 may be configured to perform or invoke any suitable functionality for modifying an image capture rate/frequency, to enforce a power cap on at least one of a plurality of servers within the physical structure, to migrate a workload from the server; to shut down or pause one or more components (e.g., servers 114 of FIG. 1). In some embodiments, the image capture frequency may continue to increase (e.g., to a predefined highest frequency) each time a captured image depicts aspects identified as being indicative of a heating event. In some embodiments, it a subsequent captured image lacks an indication that a heating event is occurring (or will likely occur), the system may reduce the image capture frequency (e.g., immediately to a predefined frequency which is less than the current frequency). In some embodiments, the system may incrementally reduce the image capture frequency (e.g., a predefined amount) for each subsequent image which is determined to lack an indication of a heating event, until a predefined lowest frequency rate is reached.

### IaaS Infrastructure Examples

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively coupled to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

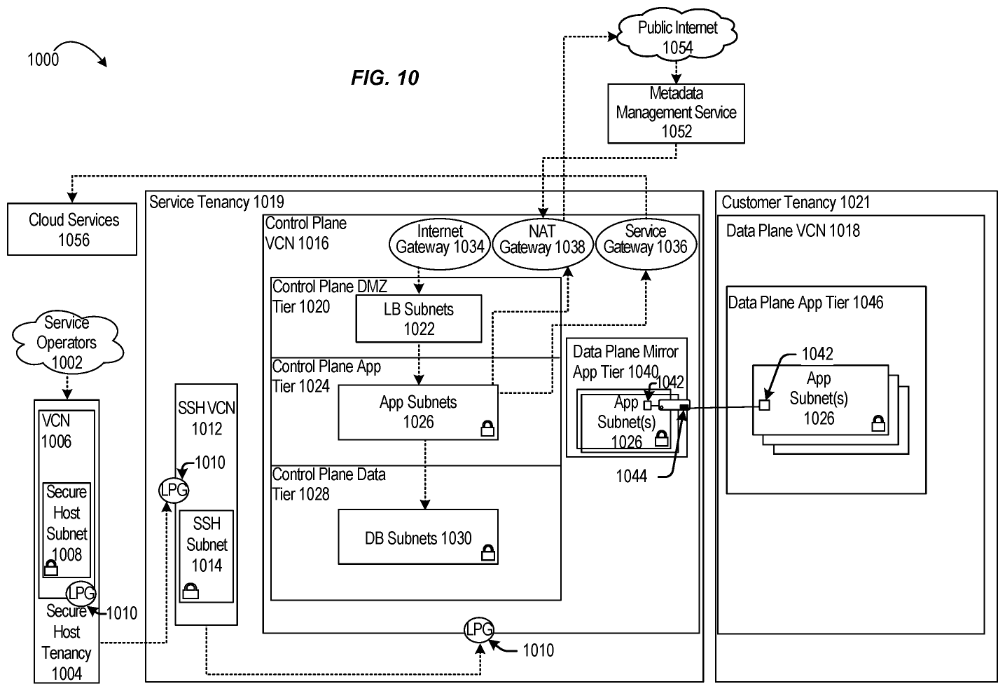

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively coupled to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, which are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

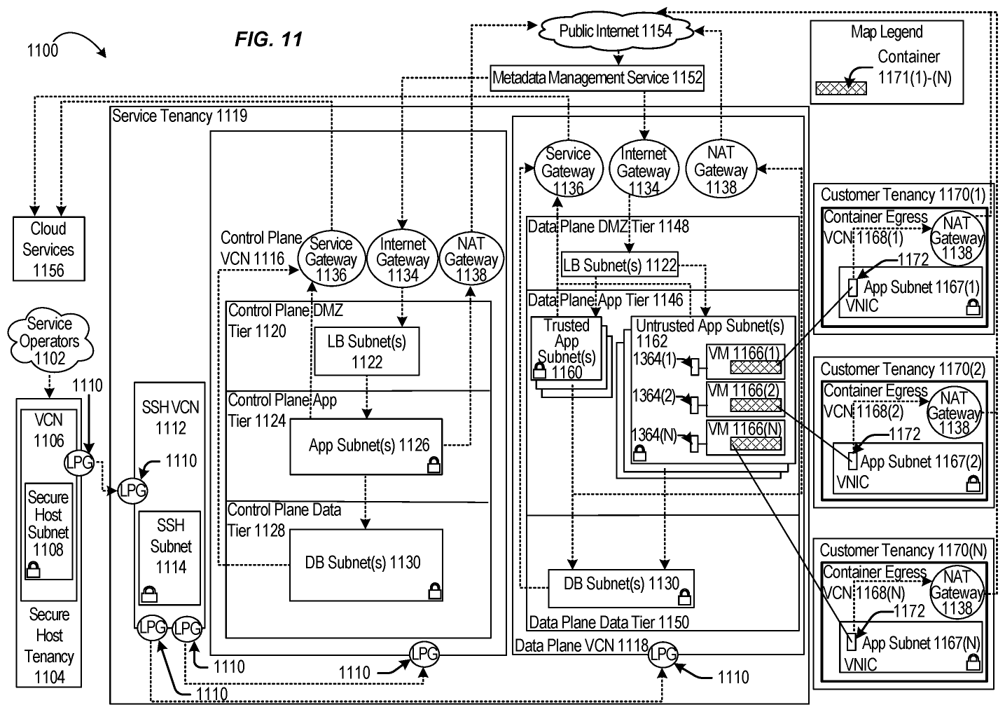

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

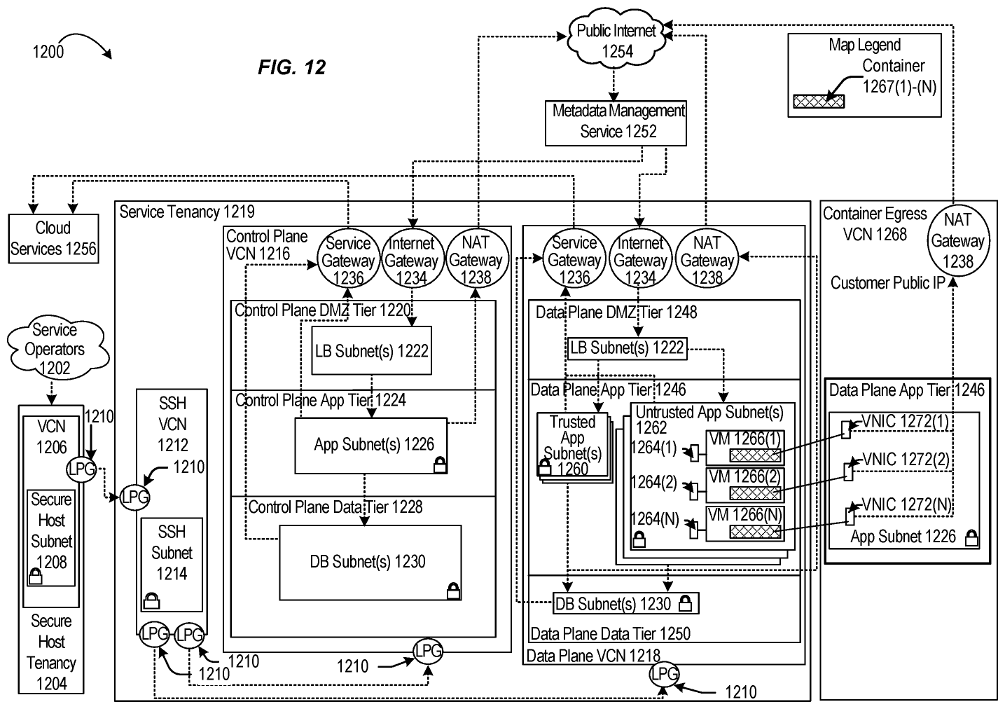

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N) and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

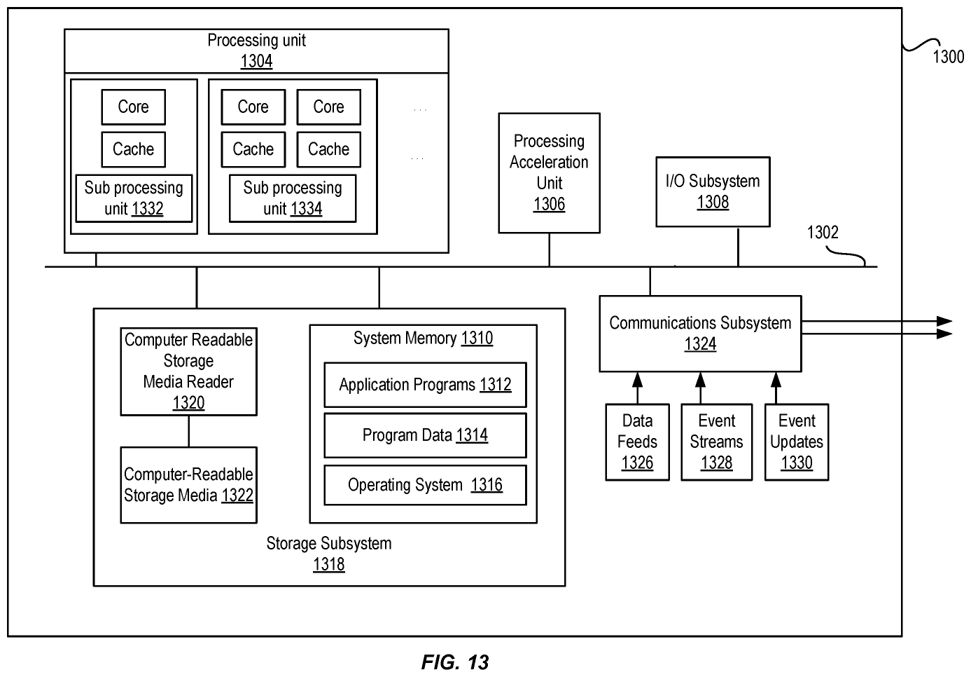

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
obtaining, by a computer system, one or more images depicting an aerial view of a physical structure;
obtaining, by the computer system, one or more attributes associated with the physical structure;
identifying, by the computer system, a surface temperature corresponding to a portion of the physical structure from the one or more images depicting the aerial view of the physical structure;
determining, by the computer system based at least in part on the surface temperature and the one or more attributes associated with the physical structure, that a capability of a temperature control system associated with the physical structure is likely insufficient to meet a temperature control requirement associated with the physical structure; and
executing, by the computing system, one or more operations based at least in part on determining that the capability of the temperature control system associated with the physical structure is likely insufficient to meet the temperature control requirement associated with the physical structure.

2. The computer-implemented method of claim 1, wherein at least one of the one or more images is an infrared image that depicts a heat signature at one or more corresponding locations of the physical structure, and wherein identifying the surface temperature corresponding to at least the portion of the physical structure comprises identifying at least one of a color or an intensity of the color within the one or more images.

3. The computer-implemented method of claim 1, wherein the one or more attributes associated with the physical structure comprises at least one of 1) operational data corresponding to one or more devices associated with powering or managing temperature within the physical structure, 2) location data identifying corresponding locations of the one or more devices associated with powering or managing the temperature within the physical structure, 3) environmental data indicating at least one or more ambient temperature values within the physical structure, or 4) a schematic of the physical structure.

4. The computer-implemented method of claim 1, wherein obtaining the one or more attributes of the physical structure comprises identifying one or more temperature control systems from the one or more images based at least in part on an object detection algorithm.

5. The computer-implemented method of claim 1, wherein the one or more images are obtained at a first frequency, and wherein executing the one or more operations comprises modifying the first frequency to a second frequency, the second frequency being more frequent than the first frequency.

6. The computer-implemented method of claim 5, wherein the one or more operations comprises at least one of: 1) enforcing a power cap on at least one of a plurality of servers within the physical structure; 2) migrating a workload from the server; or 3) shutting down or pausing the server.

7. The computer-implemented method of claim 1, wherein determining that the capability of the temperature control system is likely insufficient to meet the temperature control requirement associated with the physical structure comprises comparing the surface temperature from the one or more images depicting the aerial view of the physical structure to at least one attribute of the one or more attributes associated with the physical structure.

8. A computing device, comprising:
one or more processors; and
one or more memories storing computer-executable instructions that, when executed by the one or more processors, cause the one or more processors to:
receive an infrared image depicting an aerial view of a physical structure;
obtain operational data associated with a temperature control system configured to manage temperature within the physical structure;
provide the operational data and the infrared image to a machine-learning model as input data, wherein the machine-learning model is previously trained to identify, from an instance of operational data and a corresponding image provided as input, whether the temperature control system will likely meet a temperature control requirement associated with the physical structure; and
execute one or more operations based at least in part on output provided by the machine-learning model.

9. The computing device of claim 8, wherein the machine-learning model is trained based at least in part on a supervised machine-learning algorithm and labeled data set, the labeled data set comprising example including an operational data instance, a corresponding infrared image, and a label indicating an operational status or attribute of one or more components associated with the physical structure.

10. The computing device of claim 9, wherein the labeled data set comprises historical data associated with the physical structure, the physical structure being a datacenter.

11. The computing device of claim 8, wherein executing the computer-executable instructions further causes the one or more processors to:
obtain environmental data associated with a geographical area in which the physical structure is located; and
provide the environmental data as part of the input data to the machine-learning model.

12. The computing device of claim 8, wherein the one or more operations comprise providing a notification at a user interface.

13. The computing device of claim 8, wherein the infrared image is obtained during a monitoring process in which a plurality of infrared images depicting the aerial view of the physical structure are obtained over a period of time.

14. A non-transitory computer-readable medium comprising one or more memories storing computer-executable instructions that, when executed by one or more processors of a computing device, causes the one or more processors to:
obtain a first set of infrared images according to a first frequency, the first set of infrared images each depicting a datacenter;
detect a first temperature at a location of the datacenter based at least in part on a first infrared image of the first set of infrared images;
obtain historical data associated with the datacenter;
determine a first difference between the first temperature identified from the first infrared image and a historical temperature of the historical data associated with the datacenter; and
responsive to determining that the first difference exceeds a first threshold, perform one or more remedial actions comprising at least presenting a notification indicating the first difference at a user interface.

15. The non-transitory computer-readable medium of claim 14, wherein executing the computer-executable instructions further causes the one or more processors to correlate the first temperature identified from the first infrared image with a temperature control system of the datacenter, and wherein the notification indicates the first difference corresponds to the temperature control system.

16. The non-transitory computer-readable medium of claim 14, wherein the first set of infrared images are obtained from one or more satellite imaging sources.

17. The non-transitory computer-readable medium of claim 14, wherein executing the computer-executable instructions further causes the one or more processors to:
responsive to determining that the first difference exceeds the first threshold, obtain a second set of infrared images according to a second frequency that is greater than the first frequency;
detect a second temperature at the location of the datacenter based at least in part on a second infrared image of the second set of infrared images; and
determine a second difference between the second temperature that was identified based at least in part on the second infrared image and the historical temperature of the historical data associated with the datacenter, wherein the one or more remedial actions are performed based at least in part on determining the second difference exceeds a second threshold.

18. The non-transitory computer-readable medium of claim 17, wherein executing the computer-executable instructions further causes the one or more processors to:
identify one or more objects from the first infrared image based at least in part on executing an object detection algorithm; and
determine that an object of the one or more objects identified from the first infrared image corresponds to a temperature control system of the datacenter, wherein the second set of infrared images are obtained according to the second frequency based at least in part on determining that the object of the one or more objects identified from the first infrared image corresponds to the temperature control system of the datacenter.

19. The non-transitory computer-readable medium of claim 18, wherein the historical data associated with the datacenter comprises environmental data comprising at least one of an external humidity value, an external temperature, an ambient temperature, a wind speed, a wind direction, a cloud cover measurement, a visibility value, or a severe weather event.

20. The non-transitory computer-readable medium of claim 14, wherein executing the computer-executable instructions further causes the one or more processors to:
identify one or more objects from the first infrared image based at least in part on executing an object detection algorithm; and
determine that an object of the one or more objects identified from the first infrared image corresponds to maintenance work, wherein the notification further indicates existence of the maintenance work.
